(19) United States
(12) Patent Application Publication
(10) Pub. No.: US 2018/0057000 A1
(43) Pub. Date: Mar. 1, 2018

(54) VEHICLE AND CONTROL METHOD THEREOF

(71) Applicant: Hyundai Motor Company, Seoul (KR)

(72) Inventors: KyoungJun Lee, Seoul (KR); Changho Kim, Seoul (KR)

(21) Appl. No.: 15/362,342

(22) Filed: Nov. 28, 2016

(30) Foreign Application Priority Data
Aug. 30, 2016 (KR) 10-2016-0110570

(51) Int. Cl. B60W 30/16

(52) U.S. Cl. CPC B60W 30/16; B60W 2550/308; B60W 2710/18; B60W 2540/20; B60W 2720/10; B60W 2520/10

(57) ABSTRACT

A vehicle and a control method are provided to adjust vehicle speed when the vehicle changes lanes using a safety distance to a preceding vehicle traveling in the vehicle lane, speed of the preceding vehicle, and a safety distance to a preceding vehicle traveling in a target lane. The vehicle includes a speed sensor that senses the vehicle speed, a speed controller that adjusts the vehicle speed, and a distance sensor that detects a distance between the vehicle and a first target vehicle and the vehicle and a second target vehicle. A controller determines a first safety distance between the vehicle and the first target vehicle and a second safety distance between the vehicle and the second target vehicle, based on the sensed distances, and operates the speed controller to adjust the driving speed of the vehicle based on the first safety distance and the second safety distance.

### CROSS-REFERENCE TO RELATED APPLICATION

This application claims the benefit of Korean Patent Application No. 10-2016-0110570, filed on Aug. 30, 2016 in the Korean Intellectual Property Office, the disclosure of which is incorporated herein by reference.

### BACKGROUND

### 1. Field of the Disclosure

The present disclosure relates to a vehicle and a control method thereof, and more particularly, to a technique for adjusting the speed of a vehicle, when the vehicle changes lanes, based on a safe distance to a preceding vehicle traveling in the same lane as the vehicle, the speed of the preceding vehicle, and a safe distance to a preceding vehicle traveling in a target lane.

### 2. Description of the Related Art

In general, a vehicle is transport that travels on a road or a track to transport humans or objects to desired places. Examples of vehicles include a three-wheeled vehicle, a four-wheeled vehicle, a two-wheeled vehicle such as a motorcycle, construction equipment, a bicycle, and a train running on a track.

Recently, studies are being conducted regarding vehicles with advanced driver assist system (ADAS) for actively providing information regarding the state of a vehicle, a driver's state, and a surrounding environment to reduce the driver's load and improve convenience. An example of ADAS installed in a vehicle is a smart cruise control (SCC) system. The SCC system is capable of executing autonomous driving by accelerating or decelerating a vehicle automatically to maintain a safe distance to a preceding vehicle.

The SCC system is configured to sense another vehicle ahead of or behind a traveling vehicle and adjusts the driving speed of the vehicle to maintain a constant distance to the other vehicle, to adjust distances to other vehicles located ahead of or behind the traveling vehicle. Additionally, the SCC system is configured to adjust the speed to a target speed set by a driver when no vehicle is detected ahead of the vehicle, and when another vehicle is present ahead of the vehicle, the SCC system operates the vehicle to maintain a proper distance to the preceding vehicle, and stops the vehicle when the preceding vehicle stops.

### SUMMARY

Therefore, the present disclosure provides a technique for optimally adjusting the speed of a vehicle, when the vehicle changes lanes, based on a safe distance for a preceding vehicle traveling in the same lane as the vehicle, the speed of the preceding vehicle, and a safe distance for a preceding vehicle traveling in a target lane. Additional aspects of the disclosure will be set forth in part in the description which follows and, in part, will be obvious from the description, or may be learned by practice of the disclosure.

In accordance with one aspect of the present disclosure, a vehicle may include: a speed sensor configured to sense driving speed of the vehicle (e.g., a subject or traveling vehicle); a speed controller configured to adjust the driving speed of the vehicle; a distance sensor configured to sense a distance between the vehicle and a first target vehicle and a distance between the vehicle and a second target vehicle; and a controller configured to determine, when a lane change signal for the vehicle is received, a first safety distance between the vehicle and the first target vehicle and a second safety distance between the vehicle and the second target vehicle, based on the distances sensed by the distance sensor, and to operate the speed controller to adjust the driving speed of the vehicle based on the first safety distance and the second safety distance.

The first safety distance may be a distance required between the vehicle and the first target vehicle when changing lanes, and the second safety distance may be a distance required between the vehicle and the second target vehicle when changing lanes. The controller may be configured to select one of the first safety distance and the second safety distance, as a target vehicle distance required by the vehicle when changing lanes, wherein the selected one of the first safety distance and the second safety distance is a distance for a target vehicle to which the vehicle is located closer to than the other target vehicle.

When the first safety distance is selected as a target vehicle distance required for the vehicle to change lanes, the controller may be configured to operate the speed controller to adjust the speed such that the vehicle maintains the target vehicle distance to the first target vehicle. When the second safety distance is selected as a target vehicle distance required for the vehicle to change lanes, the controller may be configured to operate the speed controller to adjust the speed such that the vehicle maintains the target vehicle distance to the second target vehicle.

Additionally, when the distance between the vehicle and the first target vehicle is greater than or equal to a predetermined distance, the controller may be configured to operate the speed controller to increase the driving speed of the vehicle. When the distance between the vehicle and the first target vehicle is less than a predetermined distance, the controller may be configured to operate the speed controller to decrease the driving speed of the vehicle. When the distance between the vehicle and the second target vehicle is greater than or equal to a predetermined distance, the controller may be configured to operate the speed controller to increase the driving speed of the vehicle. When the distance between the vehicle and the second target vehicle is less than a predetermined distance, the controller may be configured to operate the speed controller to decrease the driving speed of the vehicle.

The vehicle may further include: a speed information acquirer configured to sense speed of the first target vehicle and speed of the second target vehicle. When the sensed speed of the first target vehicle is greater than or equal to the speed of the vehicle, the controller may be configured to operate the speed controller to increase the driving speed of the vehicle. When the sensed speed of the first target vehicle is less than the speed of the vehicle, the controller may be configured to operate the speed controller to decrease the driving speed of the vehicle. When the sensed speed of the second target vehicle is greater than or equal to the speed of the vehicle, the controller may be configured to operate the speed controller to increase the driving speed of the vehicle. When the sensed speed of the second target vehicle is less than the speed of the vehicle, the controller may be configured to operate the speed controller to decrease the driving speed of the vehicle.

The controller may further be configured to determine a minimum value of driving speed required for the vehicle to travel, based on at least one of the first safety distance, the second safety distance, the sensed speed of the first target vehicle, and the sensed speed of the second target vehicle. The controller may then be configured to operate the speed controller based on the minimum value of the driving speed. The first target vehicle may be located in the same lane as the vehicle, and the second target vehicle may be located in a target lane which the vehicle intends to enter.

In accordance with another aspect of the present disclosure, a method for controlling a vehicle may include: receiving a lane change signal for a vehicle; sensing driving speed of the vehicle; sensing a distance between the vehicle and a first target vehicle, and a distance between the vehicle and a second target vehicle; determining a first safety distance between the vehicle and the first target vehicle and a second safety distance between the vehicle and the second target vehicle, based on the sensed distances; and operating a speed controller to adjust the driving speed of the vehicle based on the first safety distance and the second safety distance.

The method may further include: selecting one of the first safety distance and the second safety distance, as a target vehicle distance required by the vehicle to change lanes, wherein the selected one of the first safety distance and the second safety distance may be a distance for a target vehicle to which the vehicle is located closer to than the other target vehicle. The operating of the speed controller may include, when the first safety distance is selected as a target vehicle distance required by the vehicle to change lanes, operating the speed controller to adjust the speed such that the vehicle maintains the target vehicle distance to the first target vehicle.

Additionally, the operating of the speed controller may include, when the second safety distance is selected as a target vehicle distance required by the vehicle to change lanes, operating the speed controller to adjust the speed such that the vehicle maintains the target vehicle distance to the second target vehicle. The operating of the speed controller may further include, when the distance between the vehicle and the first target vehicle is greater than or equal to a predetermined distance, operating the speed controller to increase the driving speed of the vehicle and when the distance between the vehicle and the first target vehicle is less than a predetermined distance, operating the speed controller to decrease the driving speed of the vehicle. Further, the operating of the speed controller may include, when the distance between the vehicle and the second target vehicle is greater than or equal to a predetermined distance, operating the speed controller to increase the driving speed of the vehicle and when the distance between the vehicle and the second target vehicle is less than a predetermined distance, operating the speed controller to decrease the driving speed of the vehicle.

The method may further include: sensing speed of the first target vehicle and speed of the second target vehicle. When the sensed speed of the first target vehicle is greater than or equal to the speed of the vehicle, the speed controller may be operated to increase the driving speed of the vehicle. When the sensed speed of the first target vehicle is less than the speed of the vehicle, the speed controller may be operated to decrease the driving speed of the vehicle. Additionally, when the sensed speed of the second target vehicle is greater than or equal to the speed of the vehicle, the speed controller may be operated to increase the driving speed of the vehicle. When the sensed speed of the second target vehicle is less than the speed of the vehicle, the speed controller may be operated to decrease the driving speed of the vehicle.

The method may further include: determining a minimum value of driving speed required for the vehicle to travel, based on at least one of the first safety distance, the second safety distance, the sensed speed of the first target vehicle, and the sensed speed of the second target vehicle. The operating of the speed controller may include, operating the speed controller based on the minimum value of the driving speed.

### BRIEF DESCRIPTION OF THE DRAWINGS

These and/or other aspects of the disclosure will become apparent and more readily appreciated from the following description of the exemplary embodiments, taken in conjunction with the accompanying drawings of which:

FIG. 1 is a perspective view schematically showing the outer appearance of a vehicle according to an exemplary embodiment of the present disclosure;

FIG. 2 shows the interior of a vehicle according to an exemplary embodiment of the present disclosure;

FIG. 3 is a control block diagram of a vehicle according to an exemplary embodiment of the present disclosure;

FIG. 4 is a conceptual view for describing operation in which a distance sensor senses a distance to another vehicle, according to an exemplary embodiment of the present disclosure;

FIG. 5 is a conceptual view for describing a method of adjusting the speed of a subject vehicle when the vehicle travels, based on a distance between the vehicle and a target vehicle and a difference in speed between the vehicle and the target vehicle, according to an exemplary embodiment of the present disclosure;

FIG. 6 is a conceptual view for describing a method of adjusting the speed of a subject vehicle when the vehicle travels, based on a predetermined distance between the vehicle and a target vehicle, according to an exemplary embodiment of the present disclosure;

FIG. 7 is a conceptual view for describing a method of adjusting the speed of a vehicle when the vehicle travels, based on the speed of a target vehicle, according to an exemplary embodiment of the present disclosure;

FIGS. 8 and 9 are conceptual views for describing a method of adjusting the speed of a vehicle based on a first safety distance for a first target vehicle and a second safety distance for a second target vehicle, according to an exemplary embodiment of the present disclosure;

FIGS. 10 to 12 are flowcharts illustrating methods of controlling a vehicle according to an exemplary embodiment of the present disclosure;

FIG. 13 shows a vehicle including a rear side vehicle sensor, according to an exemplary embodiment of the present disclosure; and

FIGS. 14, 15, and 16 are conceptual views for describing a method of adjusting the speed of a subject vehicle according to the position of another vehicle traveling on a target lane, according to another exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Like numbers refer to like elements throughout this specification. This specification does not describe all components of embodiments, and general information in the technical field to which the present disclosure belongs or overlapping information between the embodiments will not be described. The terms “part”, “module”, “member”, and “block”, as used herein, may be implemented as software or hardware, and according to embodiments, a plurality of “parts”, “modules”, “members”, or “blocks” may be implemented as a single component, or a single “part”, “module”, “member”, or “block” may include a plurality of components.

Throughout this specification, when a part is “connected” to another part, this includes the case in which the part is indirectly connected to the other part, as well as the case in which the part is directly connected to the other part, and the indirect connection includes a connection through a wireless communication network. Reference numerals used in operations are provided for convenience of description, without describing the order of the operations, and the operations can be executed in a different order from the stated order unless a specific order is definitely specified in the context.

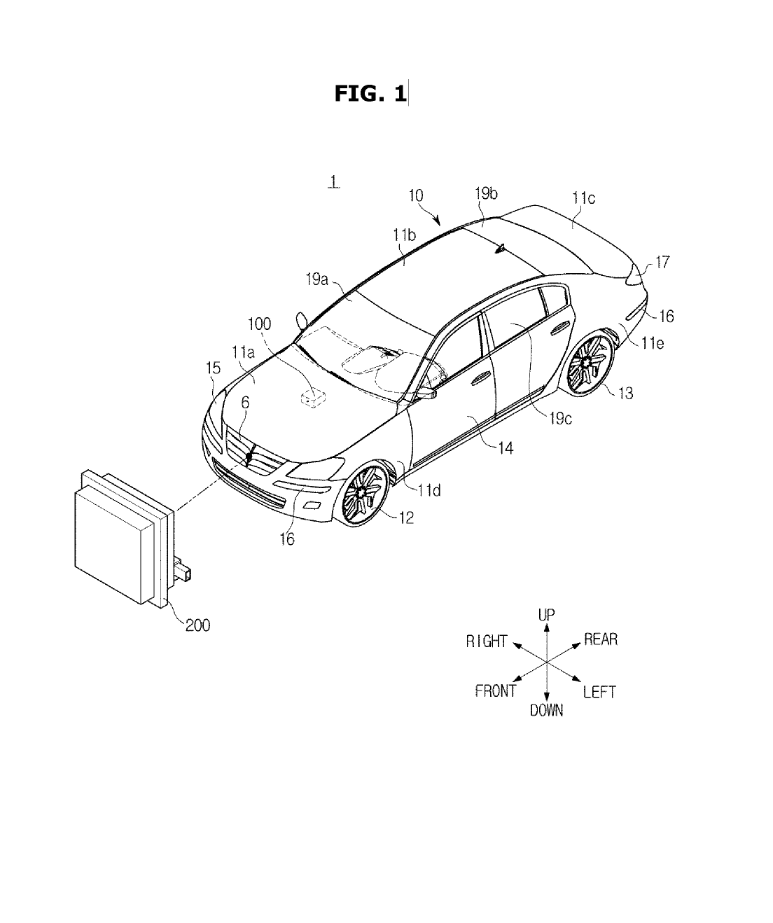

Hereinafter, the operation principle and exemplary embodiments of the present disclosure will be described with reference to the accompanying drawings. FIG. 1 is a perspective view schematically showing the outer appearance of a vehicle according to an exemplary embodiment of the present disclosure.

Hereinafter, for convenience of description, as shown in FIG. 1, a direction in which a vehicle 1 travels is defined as a front direction (e.g., a forward traveling direction), and a left direction is distinguished from a right direction with respect to the front direction. When the front direction is a 12 o'clock direction, a 3 o'clock direction or a direction around the 3 o'clock direction is defined as a right direction, and a 9 o'clock direction or a direction around the 9 o'clock direction is defined as a left direction. The opposite direction of the front direction is defined as a rear direction. Additionally, a direction towards the bottom of the vehicle 1 is defined as a down direction, and the opposite direction of the down direction is defined as an up direction. A surface of the front portion of the vehicle 1 is defined as a front surface, a surface of the rear portion of the vehicle 1 is defined as a rear surface, and surfaces of the side portions of the vehicle 1 are defined as side surfaces. The left one of the side surfaces is defined as a left surface, and the right one of the side surfaces is defined as a right surface.

Referring to FIG. 1, a vehicle 1 may include a vehicle body 10 that forms the outer appearance of the vehicle 1, and a plurality of wheels 12 and 13 configured to move the vehicle 1. The vehicle body 10 may include a hood 11a to protect various devices such as an engine required for driving the vehicle 1, a loop panel 11b that forms the internal space of the vehicle 1, a trunk lid 11c to provide storage space, and front fenders 11d and quarter panels 11e disposed at both sides of the vehicle 10. A plurality of doors 14 hinge-coupled with the vehicle body 10 may be disposed at both sides of the vehicle body 10.

A front window 19a that provides a front view of the vehicle 1 may be disposed between the hood 11a and the loop panel 11b, and a rear window 19b that provides a rear view of the vehicle 10 may be disposed between the loop panel 11b and the trunk lid 11c. A plurality of side windows 19c that provide side views of the vehicle 10 may be disposed at the upper parts of the doors 14. A plurality of headlamps 15 configured to irradiate light in a heading direction of the vehicle 1 may be disposed at the front part of the vehicle 1. Additionally, a plurality of turn signal lamps 16 configured to provide notification regarding a movement direction of the vehicle 1 may be disposed at the front and back parts of the vehicle 1.

Particularly, the vehicle 1 may operate any one of the turn signal lamps 16 flickering to provide a notification regarding a movement direction of the vehicle 1. A plurality of tail lamps 17 may be disposed at the rear part of the vehicle 1. The tail lamps 17 may provide a notification regarding a gear shifting state, a brake operation state, etc. of the vehicle 1. The vehicle 1 (e.g., a subject or traveling vehicle) may include a distance sensor 200 configured to sense at least one other vehicle located ahead of the vehicle 1 to acquire position information of the other vehicle (e.g., a first vehicle). The distance sensor 200 may be disposed in at least one part (e.g., the inner surface) of a radiator grill 6. However, the distance sensor 200 may be disposed at any location of the vehicle 1 to sense another vehicle located ahead of the vehicle 1.

At least one vehicle controller 100 may be disposed within the vehicle 1. The vehicle controller 100 may be configured to perform electronic control related to operations of the vehicle 1. The vehicle controller 100 may be installed at an arbitrary location within the vehicle 1, according to a designer's selection. For example, the vehicle controller 100 may be disposed between an engine room and a dashboard, or in the inside of a center fascia. The vehicle controller 100 may include at least one processor configured to receive electrical signals, process the received electrical signals, and output the processed electrical signals. The at least one processor may be implemented with at least one semiconductor chip and the related components. The at least one semiconductor chip and the related components may be mounted on a printed circuit board (PCB) that may be installed within the vehicle 1.

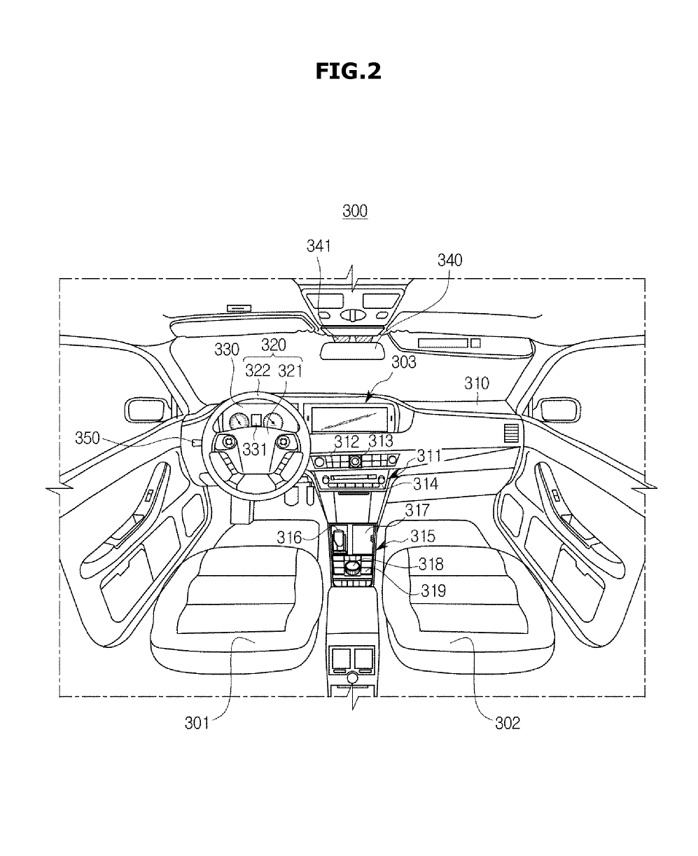

FIG. 2 shows the interior of a vehicle according to an exemplary embodiment of the present disclosure. Referring to FIG. 2, in the interior 300 of the vehicle 1, a driver seat 301, a passenger seat 302, a dashboard 310, a steering wheel 320, and an instrument panel 330 may be provided. The dashboard 310 may partition an engine room from the interior 300 of the vehicle 1, and accommodate various types of components for driving the vehicle. The dashboard 310 may be disposed in front of the driver seat 301 and the passenger seat 302. The dashboard 310 may include an upper panel, a center fascia 311, a gear box 315, etc.

On the upper panel of the dashboard 310, a vehicle display 303 may be installed. The vehicle display 303 may be configured to provide various information in the form of images for a driver or passenger of the vehicle 1. For example, the vehicle display 303 may visually provide various information, such as a map, weather, news, various moving images or still images, various information (e.g., information regarding an air conditioner) related to the state or operations of the vehicle 1, etc. Additionally, the vehicle display 303 may be configured to output a warning related to a degree of danger for the driver or passenger. More specifically, when the vehicle 1 changes lanes, the vehicle display 303 may be configured to output different warnings according to different degrees of danger for the driver or passenger. The vehicle display 303 may be implemented with a navigation system.

The vehicle display 303 may be installed in a housing integrated into the dashboard 310, and the display panel of the vehicle display 303 may be exposed to the outside. The vehicle display 303 may also be installed in the middle or lower portion of the center fascia 311. Alternatively, the vehicle display 303 may be installed on the inner surface of a wind shield 3, or on the upper surface of the dashboard 310 using a separate support (not shown). The vehicle display 303 may be installed at any other location as considered by a designer.

In the inside of the dashboard 310, various types of devices, such as a processor, a communication module, a global positioning system (GPS) receiver module, a storage device, etc., may be installed. The processor installed within the vehicle 1 may be configured to operate various electronic devices installed within the vehicle 1, or perform the functions of the vehicle controller 100 as described above. The above-described devices may be implemented with various components, such as a semiconductor chip, a switch, an integrated circuit, a resistor, a volatile or non-volatile memory, a printed circuit board (PCB), etc.

The center fascia 311 may be disposed in the center of the dashboard 310, and include input means 312 to 314 to enable the driver to input various commands related to operations of the vehicle 1. The input means 312 to 314 may be implemented as a physical button, a knob, a touch pad, a touch screen, a stick type manipulating device, a track ball, etc. The driver may manipulate the input means 311 to 314, 318, or 319 to execute various operations of the vehicle 1.

The gear box 315 may be disposed between the driver seat 301 and the passenger seat 302 below the center fascia 311. In the gear box 315, a gear 316, a storage compartment 317, and the input means 318 and 319 may be installed. The input means 318 and 319 may be implemented as a physical button, a knob, a touch pad, a touch screen, a stick type manipulating device, a track ball, etc. The storage compartment 317 and the input means 318 and 319 may be omitted according to another exemplary embodiment. In a part of the dashboard 310 positioned in front of the driver seat 301, the steering wheel 320 and the instrument panel 330 may be disposed.

The steering wheel 320 may be rotatable in a predetermined direction based on driver manipulation, and the front or rear wheels of the vehicle 1 may rotate according to the rotation direction of the steering wheel 320 to steer the vehicle 1. The steering wheel 320 may include a spoke 321 connected to a rotation axis, and a handle wheel 322 connected to the spoke 321. In the spoke 321, input means may be disposed to allow the driver to input various commands, and the input means may be implemented as a physical button, a knob, a touch pad, a touch screen, a stick type manipulating device, a track ball, etc. The handle wheel 322 may be in the shape of a circle for driver convenience, although not limited to this. In the inner side of at least one of the spoke 321 and the handle wheel 322, a vibrating unit (not shown) may be disposed to allow the at least one of the spoke 321 and the handle wheel 322 to vibrate with a predetermined strength according to an external control.

According to an exemplary embodiment, the vibrating unit may be configured to vibrate with different strengths according to external control signals, and thus, at least one of the spoke 321 and the handle wheel 322 may vibrate with different strengths according to the external control signals. The vehicle 1 may provide a haptic warning using the different strengths of vibration, to the driver. For example, at least one of the spoke 321 and the handle wheel 322 may be configured to vibrate with a degree of strength corresponding to a degree of danger determined when the vehicle 1 changes lanes to provide various warnings to the user. More specifically, at least one of the spoke 321 and the handle wheel 322 may be configured to vibrate more strongly at a higher degree of danger to provide a high level of warning to the driver.

A turn signal manipulator 350 may be disposed in the rear side of the steering wheel 320. The driver may input a signal for changing a driving direction or a lane using the turn signal manipulator 350, while driving the vehicle 1. When the driver inputs a signal for changing a driving direction using the turn signal manipulator 350, a turn indicator that indicates a desired driving direction may be turned on in the instrument panel 330, and the controller 100 may be configured to receive a direction change signal or a lane change signal for the vehicle 1. Generally, when the driver performs operation of raising the turn signal manipulator 350, the controller 100 may be configured to recognize that the traveling direction of the vehicle 1 changes to the right, and when the driver performs operation of lowering the turn signal manipulator 350, the controller 100 may be configured to recognize that the traveling direction of the vehicle 1 changes to the left.

The instrument panel 330 may provide the driver with various information related to the vehicle 1, such as speed, revolutions per minute (RPM), fuel gauge, the temperature of engine oil, information regarding turning on/off of the turn signal lamps, a mileage, etc. The instrument panel 330 may be implemented with a light, a scale plate, etc. According to an exemplary embodiment, the instrument panel 330 may be implemented with a display panel. When the instrument panel 330 is implemented with a display panel, the instrument panel 330 may be configured to display more information, such as fuel efficiency, and information regarding whether any one(s) of various functions installed in the vehicle 1 is performed, as well as the above-mentioned information, for the driver. According to an exemplary embodiment, the instrument panel 330 may be configured to output different warnings according to different degrees of danger of the vehicle 1. More specifically, when the vehicle 1 changes lanes, the instrument panel 330 may be configured to provide a driver with a predetermined warning that corresponds to a detected degree of danger.

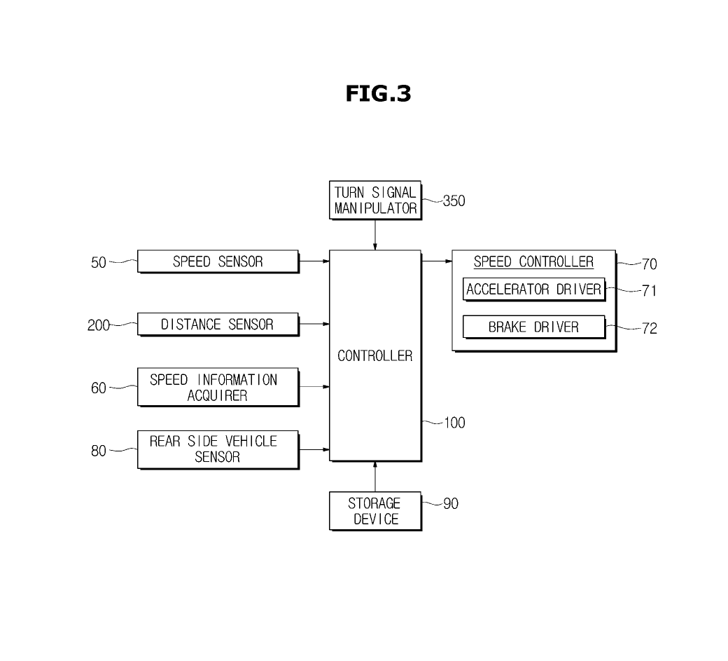

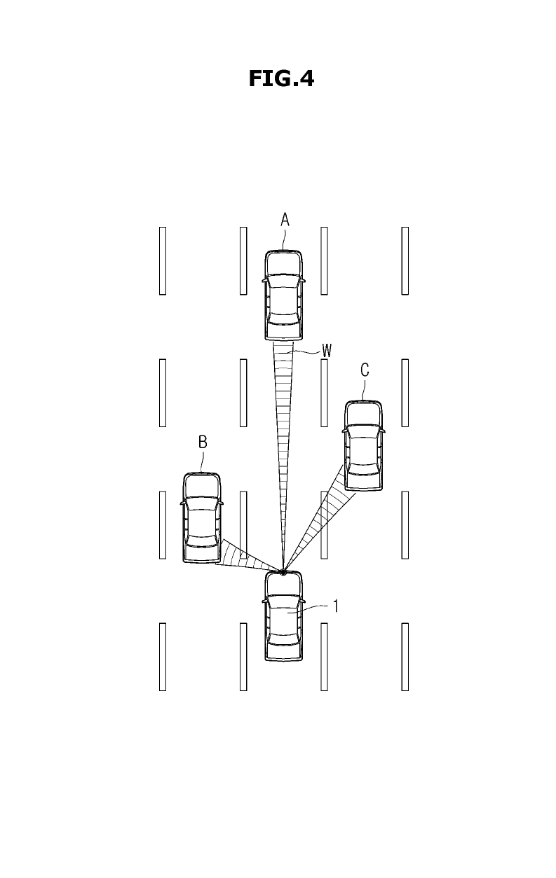

FIG. 3 is a control block diagram of a vehicle according to an exemplary embodiment of the present disclosure, and FIG. 4 is a conceptual view for describing operation in which a distance sensor senses a distance to another vehicle, according to an exemplary embodiment of the present disclosure.

Referring to FIG. 3, the vehicle 1 according to an exemplary embodiment of the present disclosure may include a speed sensor 50 configured to sense the driving speed of the vehicle 1 operated by a driver (e.g., a subject vehicle or a traveling vehicle), a speed information acquirer 60 configured to sense the speed of another vehicle (e.g., a preceding vehicle or a first detected vehicle), a speed controller 70 configured to adjust the driving speed of the vehicle 1, a rear side vehicle sensor 80 configured to sense another vehicle located behind or beside the vehicle 1 (e.g., a second detected vehicle) to acquire position information, a storage device 90 configured to store data related to the operation of the vehicle 1, the controller 100 configured to operate individual components of the vehicle 1 and to adjust the driving speed of the vehicle 1, and the turn signal manipulator 350 configured to receive a signal for changing a driving direction of the vehicle 1 or a signal for changing lanes, from the driver (e.g., based on user input).

The speed sensor 50 may be configured to sense the driving speed of the vehicle 1 under the operation of the controller 100. In other words, the speed sensor 50 may be configured to sense driving speed of the vehicle 1 using speed at which the wheels of the vehicle 1 rotate, wherein the driving speed may be expressed in unit of kph representing a movement distance (km) per unit time (h). The distance sensor 200 may be configured to sense at least one other vehicle located ahead of the vehicle 1 (e.g., the first detected or preceding vehicle) to acquire position information of the sensed vehicle. In front of the vehicle 1, another vehicle traveling ahead of the vehicle 1 in the same lane, another vehicle entering the lane of the vehicle 1 from a side lane, and another vehicle exiting the lane of the vehicle 1 may be detected. The distance sensor 200 may be configured to sense such a plurality of vehicles.

In the following exemplary embodiments, for convenience of description, other vehicles except for the subject vehicle 1 are defined as a first target vehicle and a second target vehicle. Herein, the first target vehicle may be a vehicle traveling in the same lane as the vehicle 1, and the second target vehicle may be a vehicle traveling in a target lane that the vehicle 1 intends to enter. The number of the other vehicles is not limited to two, and the other vehicles may be located in the front direction of the vehicle 1, in the rear direction of the vehicle, or in the side direction of the vehicle 1.

The distance sensor 200 may be configured to sense an angle between the subject vehicle 1 and another vehicle (e.g., the first or second target vehicle), and a distance to the other vehicle to acquire position information of the other vehicle. In other words, the distance sensor 200 may be configured to detect an angle at which another vehicle located ahead of the vehicle 1 is located with respect to the vehicle 1, and a direction in which the other vehicle is located with respect to the vehicle 1, and sense a distance to the other vehicle. The distance sensor 200 may be installed in the front portion of the vehicle 1 to sense the other vehicle located ahead of the vehicle 1, as shown in FIG. 1. For example, the distance sensor 200 may be installed in a part of the radiator grill 6, in a front bumper, or around a front number plate. However, the distance sensor 200 may be installed at any other location as considered by a designer.

Furthermore, the distance sensor 200 may be configured to determine whether any object are present ahead of the vehicle 1 or whether any object approaches the vehicle 1, using electromagnetic waves, laser light, etc. In the current exemplary embodiment, an example in which the “object” is “another vehicle” will be described. As shown in FIG. 4, the distance sensor 200 may be configured to irradiate electromagnetic waves W, such as microwaves or millimeter waves, forward, and receive the electromagnetic waves W reflected from an object (e.g., a first target vehicle A) located ahead of the vehicle 1, to thus determine whether an object such as another vehicle is present ahead of the vehicle 1 or approaches the vehicle 1. In particular, the distance sensor 200 may be configured to calculate a distance between the subject vehicle 1 and the first target vehicle A using time of arrival of the electromagnetic waves W.

The distance sensor 200 may be configured to irradiate pulse laser light, ultrasonic waves, or infrared light forward, and receive the pulse laser light, ultrasonic waves, or infrared light reflected or scattered from another vehicle located ahead of the vehicle 1, to thus determine whether another vehicle is present ahead of the vehicle 1. Additionally, the distance sensor 200 may be configured to receive visible light reflected or scattered from another vehicle located ahead of the vehicle 1 to determine whether another vehicle is present ahead of the vehicle 1.

According to which one of electromagnetic waves, pulse laser light, ultrasonic waves, infrared light, and visible light is used, a distance to another preceding vehicle which is sensed by the distance sensor 200 may change, or the influence of weather or illuminance may change when another vehicle is sensed by the distance sensor 200. The distance sensor 200 may be configured to transmit the position information of the other vehicle to the controller 100. By this method, when the vehicle 1 travels in a particular road lane, the controller 100 may be configured to determine whether another vehicle travels ahead of the vehicle 1 in that same lane, whether another vehicle is traveling in the adjacent lane, whether another vehicle traveling in the adjacent lane approaches the vehicle 1, or a distance to another vehicle.

The distance sensor 200 may be implemented with, for example, a radar using millimeter waves or microwaves, Light Detection and Ranging (LiDAR) using pulse laser light, vision using visible light, an infrared sensor using infrared light, or an ultrasonic sensor using ultrasonic waves. The distance sensor 200 may be implemented with any one of the above-mentioned devices, or a combination of two or more of the above-mentioned devices. Additionally, the speed information acquirer 60 may be configured to sense the driving speed of another vehicle. The speed information acquirer 60 may particularly by configured to sense the speed of another vehicle located ahead of the vehicle 1, from signal reception time, signal reception strength, a change in frequency, a change in polarization state, etc. based on a signal received by the distance sensor 200, as described above.

Further, the speed controller 70 may be configured to sense the speed of the subject vehicle 1. The speed controller 70 may include an accelerator driver 71 and a brake driver 72. The accelerator driver 71 may be configured to operate an accelerator according to a control signal received from the controller 100 to increase the speed of the vehicle 1 (e.g., varies the engagement degree of the accelerator pedal), and the brake driver 72 may be configured to operate a brake according to a control signal received from the controller 100 to decrease the speed of the vehicle 1 (e.g., varies the engagement degree of the brake pedal). The controller 100 may be configured to compare a distance to a target vehicle sensed by the distance sensor 200 to a predetermined reference distance stored in the storage device 700, and when the controller 100 determines that the distance to the target vehicle is less than the predetermined reference distance, the controller 100 may be configured to decrease the driving speed of the vehicle 1 to increase a distance to the target vehicle. When the controller 100 determines that the distance to the target vehicle is greater than the predetermined reference distance, the controller 100 may be configured to increase the driving speed of the vehicle 1 to decrease a distance to the target vehicle.

The rear side vehicle sensor 80 may be configured to determine whether an object, for example, another vehicle is present or approaches in the side direction of the vehicle 1, in the rear direction of the vehicle 1, or in an arbitrary direction (hereinafter, referred to as a rear side direction) between the side and rear directions of the vehicle 1. The rear side vehicle sensor 80 may be implemented with various devices, such as, for example, a radar using millimeter waves or microwaves, LiDAR using pulse laser light, vision using visible light, an infrared sensor using infrared light, or an ultrasonic sensor using ultrasonic waves. The rear side vehicle sensor 80 may be implemented with any one of the above-mentioned devices, or a combination of two or more of the above-mentioned devices.

The storage device 90 may be configured to store various data related to the operation of the vehicle 1 according to an exemplary embodiment of the present disclosure. The distance sensor 200 may be configured to sense a distance between the subject vehicle 1 and another vehicle, and the storage device 90 may be configured to store data of the sensed distance. Additionally, the storage device 90 may be configured to store data of a safe distance required between the vehicle 1 and the other vehicle for the vehicle 1 to change lanes, and also the storage device 90 may be configured to store distance information and speed information used as criteria for adjusting the driving speed of the vehicle 1.

The storage device 90 may be implemented as one of storage media, such as a cache, Read Only Memory (ROM), Programmable Read Only Memory (PROM), Erasable Programmable Read Only Memory (EPROM), Electrically Erasable Programmable ROM (EEPROM), a non-volatile memory device such as flash memory, a volatile memory device such as Random Access Memory (RAM), Hard Disk Drive (HDD), and Compact Disc Read-Only Memory (CD-ROM), although not limited to these. The storage device 90 may be memory implemented as a separate chip from the processor described above in regard of the controller 100, or may be integrated into a single chip together with the processor.

The controller 100 may be configured to execute operations of the individual components installed within the vehicle 1 to operate the vehicle 1 according to an exemplary embodiment of the present disclosure. In other words, the controller 100 may be configured to receive a lane change signal input by the driver through the turn signal manipulator 350, and determine a first safety distance between the vehicle 1 and the first target vehicle A and a second safety distance between the vehicle 1 and the second target vehicle B, based on a distance sensed by the distance sensor 200. Further, a smart cruise control (SCC) system may be configured to adjust the speed of the vehicle 1 automatically to maintain a safe distance to a preceding vehicle. The SCC system may be configured to perform overtake assist control (OAC) when the driver changes the lane of the vehicle 1.

Under the OAC, the speed of the vehicle 1 may be adjusted based on a predetermined OAC distance for changing lanes, wherein the OAC distance indicates a safe distance required by the vehicle 1 when changing lanes in consideration of a distance to a target vehicle traveling ahead of the vehicle 1. In other words, the safe distance may be determined based on information regarding a distance to a target vehicle sensed by the distance sensor 200, and the controller 100 may be configured to adjust the speed of the vehicle 1 to prevent a distance between the vehicle 1 and the target vehicle from being less than the safety distance when the vehicle 1 changes lanes.

In the current exemplary embodiment, for convenience of description, a safe distance required between the vehicle 1 and the first target vehicle A when changing lanes is defined as a “first safety distance”, and a safety distance required between the vehicle 1 and the second target vehicle B when changing lanes is defined as a “second safety distance”. Since the first target vehicle A is a vehicle traveling in the same lane as the vehicle 1, and the second target vehicle B is a vehicle traveling in a target lane that the vehicle 1 intends to enter, the controller 100 may be configured to detect both the first safety distance and the second safety distance, and adjust the speed of the vehicle 1 based on the first safety distance and the second safety distance when the vehicle 1 changes lanes.

More specifically, the controller 100 may be configured to select one of the first safety distance and the second safety distance, as a target vehicle distance required by the vehicle 1 to change lanes, wherein the selected one of the first safety distance and the second safety distance is a distance for a target vehicle to which the vehicle 1 is located closer to than the other target vehicle. When the controller 100 selects the first safety distance as a target vehicle distance required by the vehicle 1 to change lanes, the controller 100 may be configured to adjust the speed controller 70 to prevent the distance between the vehicle 1 and the first target vehicle A from being less than the target vehicle distance. Additionally, when the controller 100 selects the second safety distance as a target vehicle distance required by the vehicle 1 to change lanes, the controller 100 may be configured to operate the speed controller 70 to prevent the distance between the vehicle 1 and the second target vehicle B from being less than the target vehicle distance.

Furthermore, the controller 100 may be configured to adjust the speed of the vehicle 1 based on the distance between the vehicle 1 and the first target vehicle A and a difference in relative speed between the vehicle 1 and the first target vehicle A, and adjust the speed of the vehicle 1 based on the distance between the vehicle 1 and the second target vehicle B and a difference in relative speed between the vehicle 1 and the second target vehicle B. The controller 100 may include a memory (not shown) configured to store an algorithm for executing operations of the components in the vehicle 1 or data of a program for executing the algorithm, and a processor (not shown) configured to perform the operations using the data stored in the memory. The memory and the processor may be implemented as separate chips or a single chip.

Referring to FIG. 4, a plurality of other vehicles A, B, and C may be detected ahead of the subject vehicle 1, and the distance sensor 200 may be configured to sense the other vehicles A, B, and C to calculate distances to the other vehicles A, B, and C. When the distance sensor 200 senses a preceding vehicle A traveling in the same lane as the vehicle 1, the distance sensor 200 may be configured to acquire information regarding a distance between the vehicle 1 and the other vehicle A. When the distance sensor 200 senses other preceding vehicles B and C traveling in different lanes than the vehicle 1, the distance sensor 200 may be configured to acquire information regarding distances to the other vehicles B and C, and information regarding directions and angles of the other vehicles B and C with respect to the traveling direction of the vehicle 1. The vehicles A, B, and C may be referred to as a first target vehicle, a second target vehicle, and a third target vehicle.

The distance sensor 200 may further be configured to sense other vehicles ahead in real time and store position information of the other vehicles, acquired by the above-described method, in the storage device 90. At least one component may be added or omitted in correspondence to the functions of the components of the vehicle 1 shown in FIG. 3. Also, it will be obvious to one of ordinary skill in the art that the relative positions of the components may change in correspondence to the performance or structure of the system. Meanwhile, each of the components shown in FIG. 3 indicates a hardware component, such as software and/or Field Programmable Gate Array (FPGA) and Application Specific Integrated Circuit (ASIC).

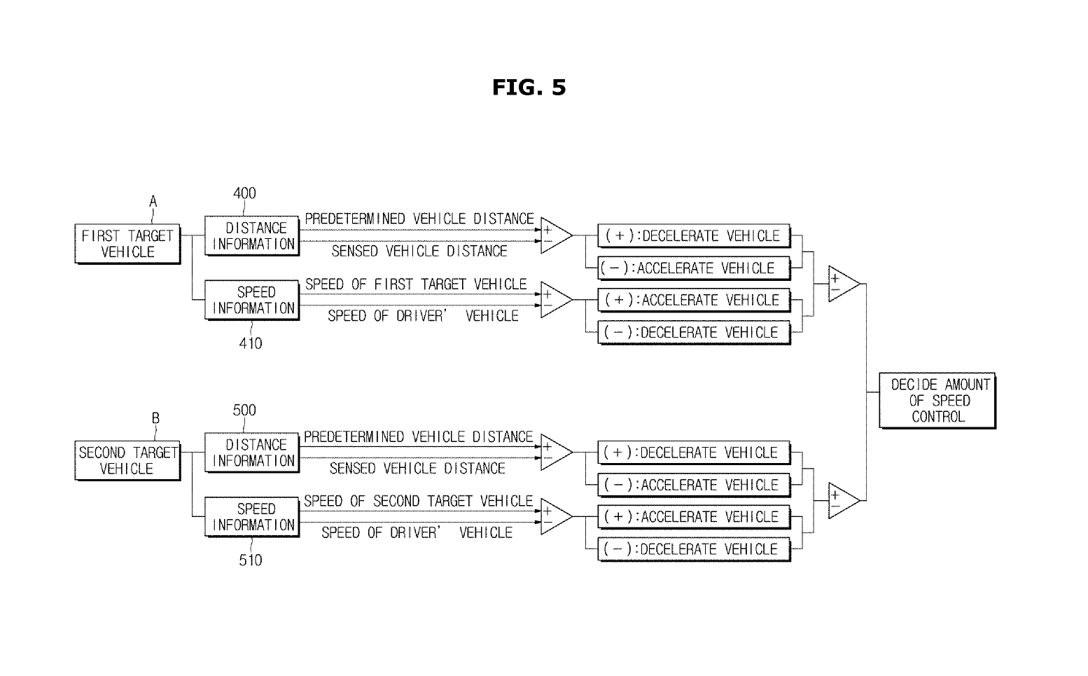

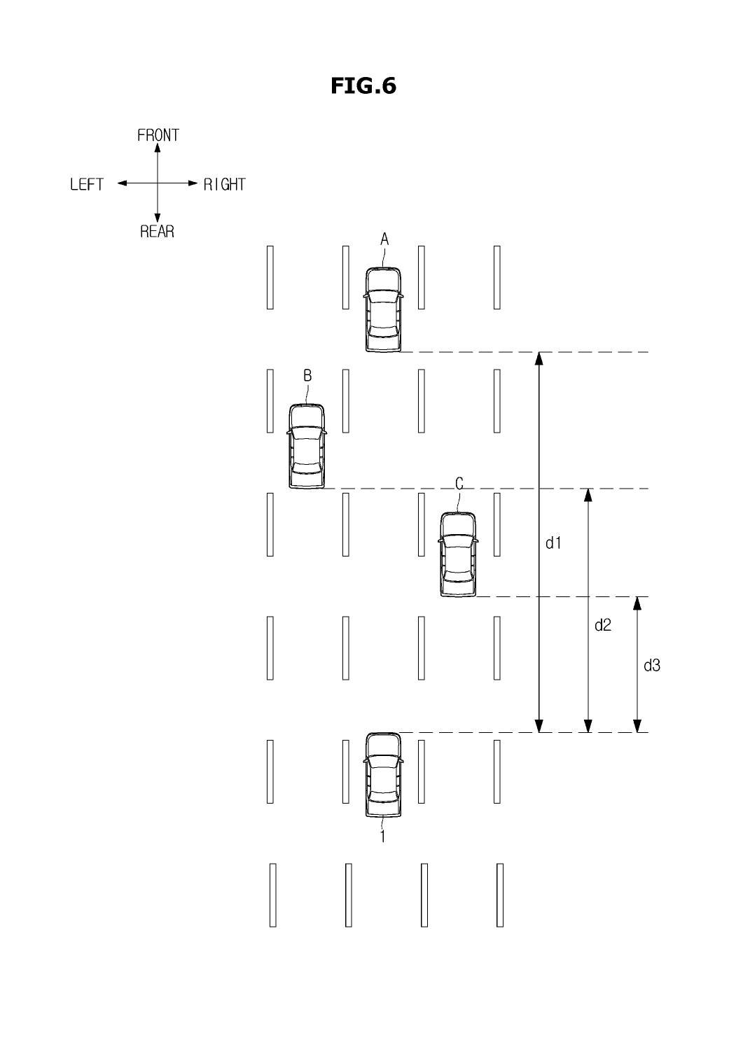

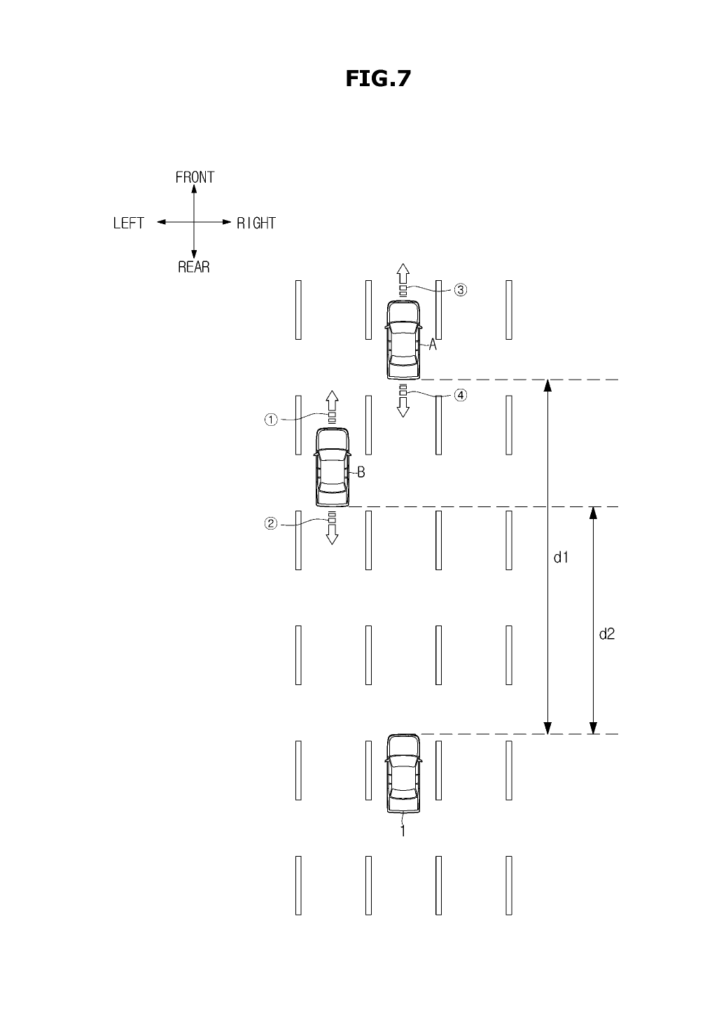

FIG. 5 is a conceptual view for describing a method of adjusting the speed of a vehicle, based on a distance between the vehicle and a target vehicle and a difference in speed between the vehicle and the target vehicle, according to an exemplary embodiment of the present disclosure. FIG. 6 is a conceptual view for describing a method of adjusting the speed of a subject vehicle, based on a predetermined distance between the vehicle and a target vehicle, according to an exemplary embodiment of the present disclosure. FIG. 7 is a conceptual view for describing a method of adjusting the speed of a vehicle, based on the speed of a target vehicle, according to an exemplary embodiment of the present disclosure.

Referring to FIG. 5, the controller 100 of the vehicle 1 may use information 400 and 500 regarding distances to preceding vehicles and information 410 and 510 regarding the speeds of the preceding vehicles, to operate the speed controller 70 to adjust the speed of the vehicle 1. In other words, the controller 100 may be configured to increase the speed of the vehicle 1 when the vehicle 1 is distant from a preceding vehicle (e.g., the distance between the vehicles is greater than a predetermined distance), and decrease the speed of the vehicle 1 when the vehicle 1 is close to the preceding vehicle (e.g. is within a predetermined distance range to the preceding vehicle). Additionally, when the speed of the vehicle 1 is high (e.g., greater than a predetermined speed), and the speed of the preceding vehicle is low (e.g., less than the predetermined speed), the controller 100 may be configured to decrease the speed of the vehicle 1, and when the speed of the vehicle 1 is low, and the speed of the preceding vehicle is high, the controller 100 may be configured to increase the speed of the vehicle 1.

Referring to FIGS. 5 and 6, the controller 100 may be configured to adjust the speed of the vehicle 1, based on information regarding distances to a first target vehicle A and a second target vehicle B, sensed by the distance sensor 200, and predetermined vehicle distance information stored in the storage device 90. The first target vehicle A may be a vehicle traveling in the same lane as the vehicle 1, and the second target vehicle B may be a vehicle traveling in a target lane which the driver intends to enter when changing lanes. When the driver does not change the lane of the vehicle 1, the controller 100 may consider only the distance between the vehicle 1 and the first target vehicle A traveling in the same lane and the speed of the first target vehicle A.

However, when the driver changes the lane of the vehicle 1, the controller 100 may be required to adjust the speed of the vehicle 1 in consideration of the speed of the first target vehicle A, the speed of the second target vehicle B, the distance between the vehicle 1 and the first target vehicle A, and the distance between the vehicle 1 and the second target vehicle B. As shown in FIG. 6, a predetermined distance which the vehicle 1 needs to maintain to the first target vehicle A being a preceding vehicle when traveling is d1, a predetermined distance which the vehicle 1 needs to maintain to the second target vehicle B is d2, and a predetermined distance which the vehicle 1 needs to maintain to a third target vehicle C is d3. The predetermined distances d2 and d3 may be distances which the vehicle 1 needs to maintain to the second target vehicle B or the third target vehicle C when changing lanes to travel in the same lane as the second target vehicle B or the third target vehicle C.

A predetermined distance that required between the vehicle 1 and a preceding vehicle may be based on data set by a user and then stored in the storage device 90, or data set by the SCC system. The controller 100 may be configured to compare a distance between the vehicle 1 and the first target vehicle A to the predetermined distance d1, and generate a control command for increasing the driving speed of the vehicle 1 when the distance between the vehicle 1 and the first target vehicle A is greater than or equal to the predetermined distance d1. Meanwhile, when the distance between the vehicle 1 and the first target vehicle A is less than the predetermined distance d1, the controller 100 may be configured to generate a control command for decreasing the driving speed of the vehicle 1.

Similarly, when the driver changes the lane of the vehicle 1 to the left lane, the controller 100 may be configured to compare a distance between the vehicle 1 and the second target vehicle B to the predetermined distance d2, and generate a control command for increasing the driving speed of the vehicle 1 when the distance between the vehicle 1 and the second target vehicle B is greater than or equal to the predetermined distance d2. Meanwhile, when the distance between the vehicle 1 and the second target vehicle B is less than the predetermined distance d2, the controller 100 may be configured to generate a control command for decreasing the driving speed of the vehicle 1.

Additionally, the controller 100 may be configured to compare the speed of the vehicle 1 to the speed of the first target vehicle A acquired by the speed information acquirer 60, and generate a control command for increasing the driving speed of the vehicle 1 when the speed of the first target vehicle A is greater than or equal to the speed of the vehicle 1. This corresponds to when the relative speed of the first target vehicle A with respect to the vehicle 1 is a positive (+) value. Meanwhile, when the speed of the first target vehicle A is less than the speed of the vehicle 1, the controller 100 may be configured to generate a control command for decreasing the driving speed of the vehicle 1. This corresponds to when the relative speed of the first target vehicle A with respect to the vehicle 1 is a negative (−) value.

When the driver changes the lane of the vehicle 1 to the left lane, the controller 100 may be configured to compare the speed of the second target vehicle B acquired by the speed information acquirer 60 to the speed of the vehicle 1, and generate a control command for increasing the driving speed of the vehicle 1 when the speed of the second target vehicle B is greater than or equal to the speed of the vehicle 1. Meanwhile, when the speed of the second target vehicle B is less than the speed of the vehicle 1, the controller 100 may be configured to generate a control command for decreasing the driving speed of the vehicle 1.

Accordingly, when the vehicle 1 traveling in the same lane as the first target vehicle A changes the lane to another lane (e.g., changes from a first lane to a second lane) in which the second target vehicle B travels, the controller 100 may be configured to determine an amount of control for adjusting the driving speed of the vehicle 1, in consideration of the distance between the vehicle 1 and the first target vehicle A, the speed of the first target vehicle A, the distance between the vehicle 1 and the second target vehicle B, and the speed of the second target vehicle B. In other words, for example, when the speed of the first target vehicle A is less than the speed of the vehicle 1 although the distance between the vehicle 1 and the first target vehicle A is greater than or equal to the predetermined distance d1, the controller 100 may first be configured to generate a control command for decreasing the driving speed of the vehicle 1. [NOTE: If possible, please provide exemplary predetermined distances.]

Referring to FIG. 7, cases in which the speeds of the first target vehicle A and the second target vehicle B increase or decrease gradually are shown. In cases \textcircled{1} and \textcircled{3} in which the speed of the first target vehicle A or the second target vehicle B increases gradually to increase the distance between the first target vehicle A or the second target vehicle B and the vehicle 1, the controller 100 may be configured to generate a control command for increasing the speed of the vehicle 1. Meanwhile, in cases \textcircled{2} and \textcircled{4} in which the speed of the first target vehicle A or the second target vehicle B decreases gradually to decrease the distance between the first target vehicle A or the second target vehicle B and the vehicle 1, the controller 100 may be configured to generate a control command for decreasing the speed of the vehicle 1.

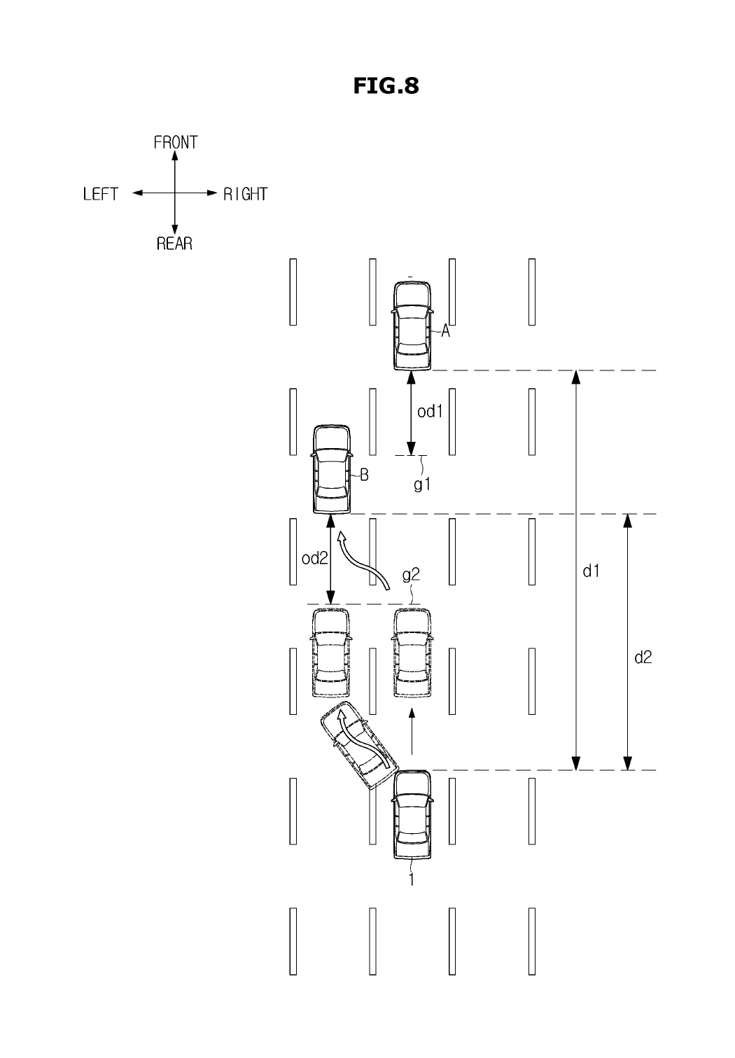

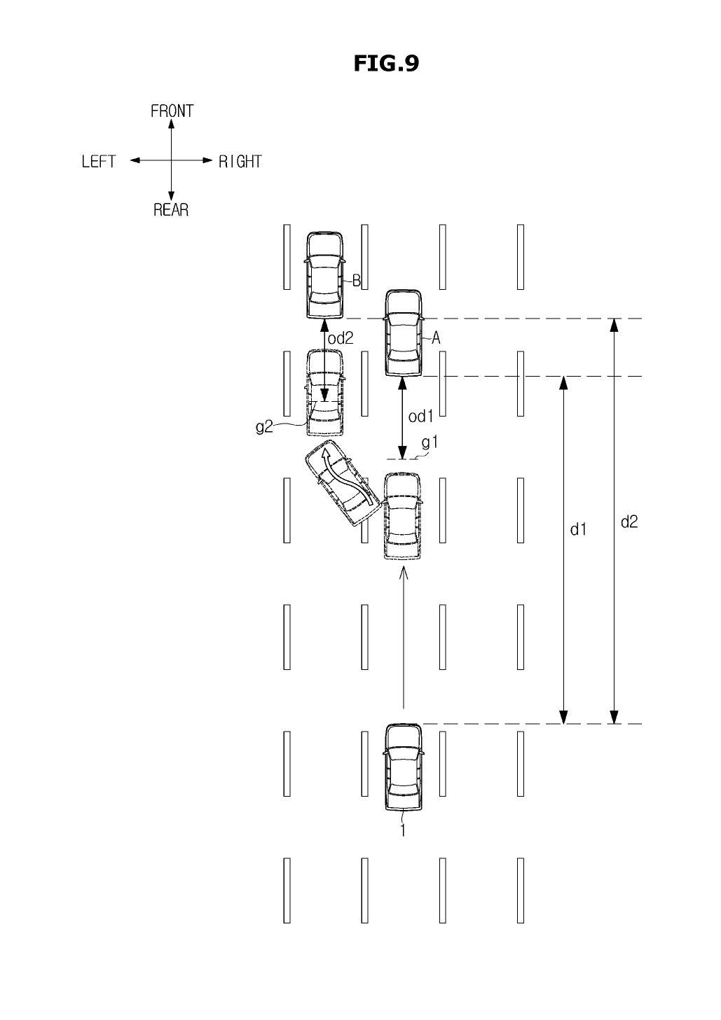

FIGS. 8 and 9 are conceptual views for describing a method of adjusting the speed of a vehicle based on a first safety distance for a first target vehicle and a second safety distance for a second target vehicle, according to an exemplary embodiment of the present disclosure. As described above, a safe distance required between the vehicle 1 and the first target vehicle A when the vehicle 1 changes lanes is defined as a “first safety distance od1”, and a safety distance required between the vehicle 1 and the second target vehicle B when the vehicle 1 changes lanes is defined as a “second safety distance od2”.

When the controller 100 receives a lane change signal while the vehicle 1 travels, the controller 100 may be configured to determine a first safety distance od1 for the first target vehicle A sensed by the distance sensor 200. After the controller 100 determined the first safety distance od1, the controller 100 may be configured to adjust the speed controller 70 to increase the driving speed of the vehicle 1, and to accelerate the vehicle 1 until a start point g1 of the first safety distance od1. In other words, the driver may smoothly change the lane to the left lane, while accelerating the vehicle 1 until the start point g1 of the first safety distance od1. However, when the controller 10 determines only the first safety distance od1 for the first target vehicle A, the vehicle 1 may fail to change the lane due to the second target vehicle B traveling on the left lane, although accelerating until the start point g1 of the first safety distance od1. In other words, when the second target vehicle B is not considered prior to lane change, a collision risk increases. Accordingly, the controller 100 may be configured to determine both the first safety distance od1 for the first target vehicle A and a second safety distance od2 for the second target vehicle B.

The controller 100 may be configured to select one of the first safety distance od1 and the second safety distance od2, as a target vehicle distance required by the vehicle 1 when changing lanes, wherein the selected one of the first safety distance od1 and the second safety distance od2 is a distance for a target vehicle to which the vehicle 1 is located closer to than the other target vehicle. In other words, as shown in FIG. 8, since the second target vehicle B is closer to the vehicle 1 than the first target vehicle A, a start point g2 of the second safety distance od2 is closer to the vehicle 1 than the start point g1 of the first safety distance od1.

Accordingly, the controller 100 may be configured to select the second safety distance od2 as a target vehicle distance required by the vehicle 1 when changing lanes, and adjust the speed controller 70 such that the vehicle 1 maintains the target vehicle distance to the second target vehicle B. In other words, the controller 100 may be configured to operate the vehicle 1 to accelerate until the start point g2 of the second safety distance od2, to allow for a risk free change to the left lane, while accelerating the vehicle 1 until the start point g2 of the second safety distance od2. However, the driver may also change the lane to the left lane in advance before accelerating the vehicle 1 until the start point g2 of the second safety distance od2.

FIG. 9 shows a case in which the second target vehicle B is more distant from the vehicle 1 than the first target vehicle A. In particular, since the first target vehicle A is closer to the vehicle 1 than the second target vehicle B, the start point g1 of the first safety distance od1 is closer to the vehicle 1 than the start point g2 of the second safety distance od2. Accordingly, the controller 100 may be configured to select the first safety distance od1 as a target vehicle distance required by the vehicle 1 when changing lanes, and adjust the speed controller 70 such that the vehicle 1 maintains the target vehicle distance to the first target vehicle A. In other words, the controller 100 may be configured to operate the vehicle 1 to accelerate until the start point g1 of the first safety distance od1, to change to the left lane without collision risk, while accelerating the vehicle 1 until the start point g1 of the first safety distance od1. However, the driver may change the lane to the left lane in advance before accelerating the vehicle 1 until the start point g1 of the first safety distance od1.

Likewise, in the exemplary embodiments of FIGS. 8 and 9, as described above with reference to FIGS. 5 to 7, the controller 100 may be configured to determine an amount of control for adjusting the speed of the vehicle 1, in consideration of the speed of the first target vehicle A, the speed of the second target vehicle B, the distance between the vehicle 1 and the first target vehicle A, and the distance between the vehicle 1 and the second target vehicle B.

Referring again to FIG. 5, the controller 100 may be configured to determine a minimum value of driving speed required for the vehicle 1 to travel, based on at least one of the first safety distance od1, the second safety distance od2, the speed of the first target vehicle A, and the speed of the second target vehicle B. In other words, the controller 100 may be configured to determine an amount of control for increasing or decreasing the driving speed of the vehicle 1 based on the first safety distance od1 and the second safety distance od2, and an amount of control for increasing or decreasing the driving speed of the vehicle 1 based on the speed of the first target vehicle A and the speed of the second target vehicle B.

The controller 100 may then be configured to select the lowest driving speed from amounts of control for driving speed of the vehicle 1, determined based on a relationship with at least one of the first safety distance od1, the second safety distance od2, the speed of the first target vehicle A, and the speed of the second target vehicle B, and adjust the speed controller 70 according to the selected driving speed. For example, when an amount of control for decreasing the speed of the vehicle 1 is determined in consideration of the speed of the first target vehicle A although an amount of control for increasing the speed of the vehicle 1 is determined in consideration of the first safety distance od1, the controller 100 may be configured to adjust driving speed according to the amount of control at which the driving speed of the vehicle 1 is minimized. This can be applied in the same manner to relationships with the first target vehicle A and the second target vehicle B.

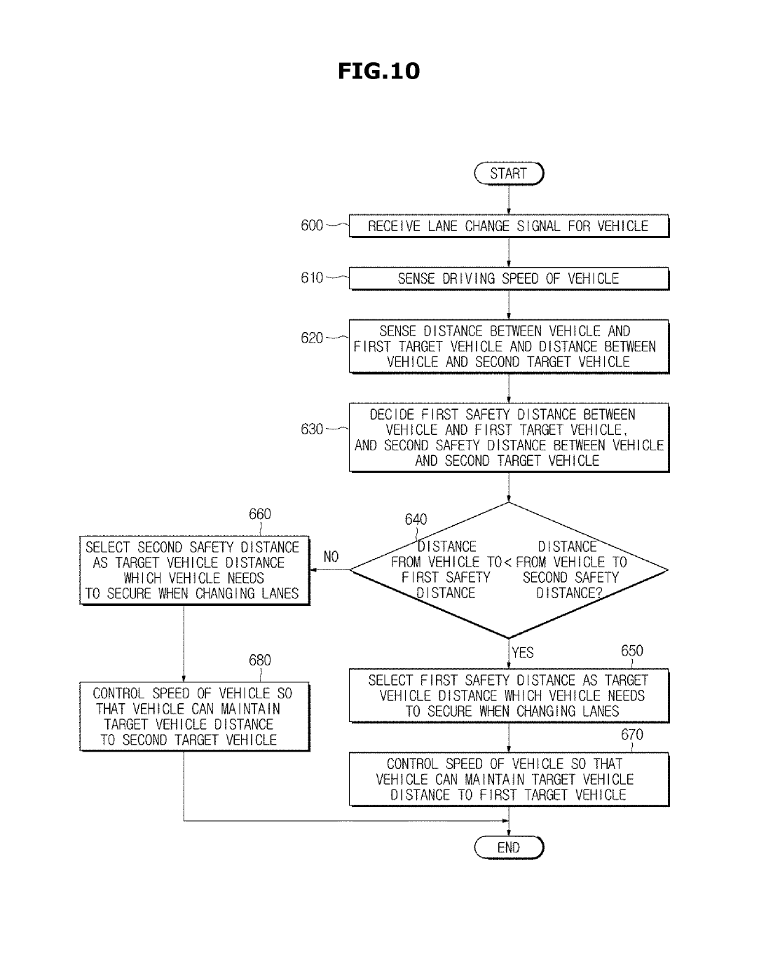

FIGS. 10 to 12 are flowcharts illustrating methods of controlling a vehicle according to an exemplary embodiment of the present disclosure. Referring to FIG. 10, the controller 100 may be configured to receive a lane change signal for the vehicle 1, in operation 600. The lane change signal may be input by a user through the turn signal manipulator 350 or the input means 312, 313 or 314, or the lane change signal may be transmitted automatically from the SCC system.

The speed sensor 50 may be configured to sense the driving speed of the vehicle 1, in operation 610, and transfer information regarding the sensed driving speed to the controller 100. The distance sensor 200 may be configured to sense a distance between the vehicle 1 and the first target vehicle A, and a distance between the vehicle 1 and the second target vehicle B, in operation 620, and transfer data of the sensed distances to the controller 100. Then, the controller 100 may be configured to determine a first safety distance od1 between the vehicle 1 and the first target vehicle A, and a second safety distance od2 between the vehicle 1 and the second target vehicle B, in operation 630.

The controller 100 may be configured to compare a distance from the vehicle 1 to the first safety distance od1, to a distance from the vehicle 1 to the second safety distance od2, in operation 640. When a start point g1 of the first safety distance od1 is closer to the vehicle 1 than a start point g2 of the second safety distance od2, the controller 100 may be configured to select the first safety distance od1 as a target vehicle distance required by the vehicle 1 when changing lanes, in operation 650. Meanwhile, when the start point g2 of the second safety distance od2 is closer to the vehicle 1 than the start point g1 of the first safety distance od1, the controller 100 may be configured to select the second safety distance od2 as a target vehicle distance required by the vehicle 1 when changing lanes, in operation 660.

When the controller 100 selects the first safety distance od1 as a target vehicle distance required by the vehicle 1 when changing lanes, the controller 100 may be configured to adjust the speed of the vehicle 1 to maintain the target vehicle distance between the subject vehicle 1 and the first target vehicle A, in operation 670. In other words, the controller 100 may be configured to operate the vehicle 1 to accelerate until the start point g1 of the first safety distance od1, to allow for a change to the left lane without collision risk, while accelerating the vehicle 1 until the start point g1 of the first safety distance od1.

When the controller 100 selects the second safety distance od2 as a target vehicle distance required by the vehicle 1 when changing lanes, the controller 100 may be configured to adjust the speed of the vehicle 1 to maintain the target vehicle distance between the subject vehicle 1 and the second target vehicle B, in operation 680. In other words, the controller 100 may be configured to operate the vehicle 1 to accelerate until the start point g2 of the second safety distance od2, to allow for a change to the left lane without collision risk, while accelerating the vehicle 1 until the start point g2 of the second safety distance od2.

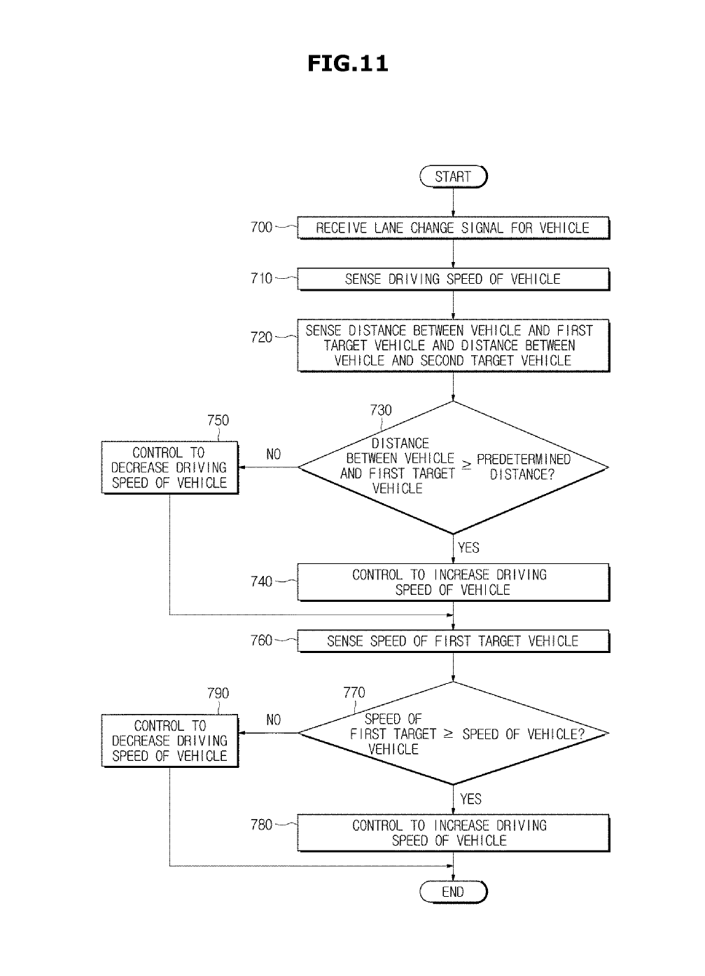

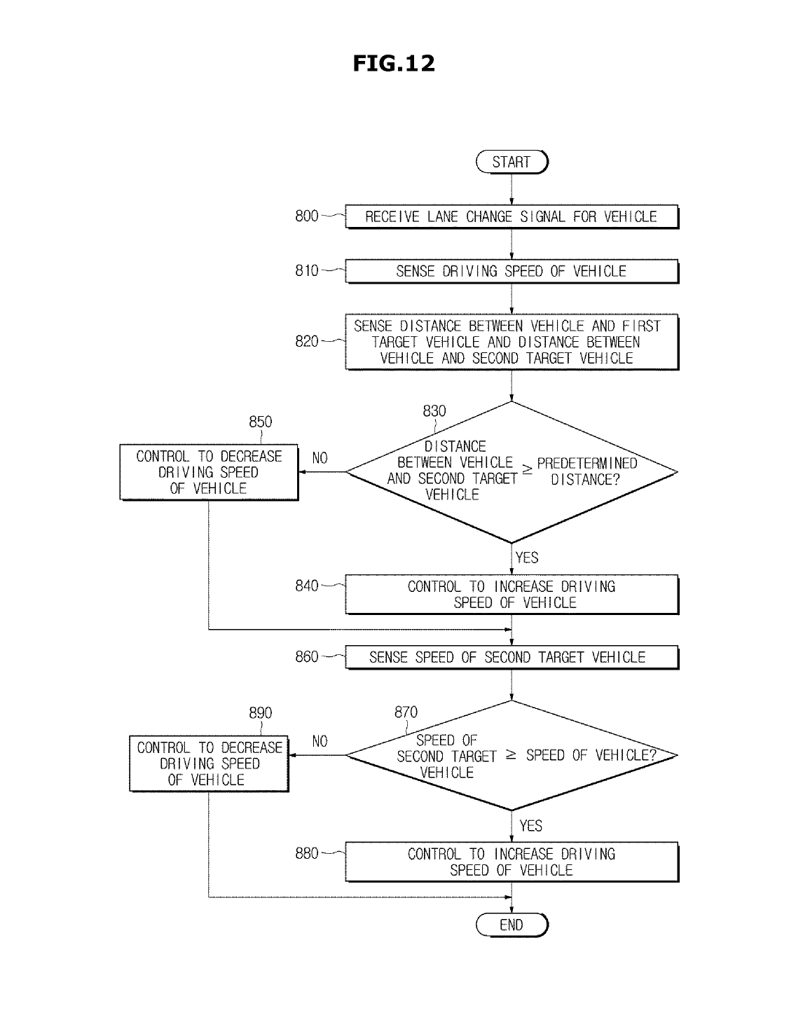

FIGS. 11 and 12 are flowcharts illustrating methods of controlling the vehicle 1 described above with reference to FIGS. 5 to 7. Referring to FIG. 11, the controller 100 may be configured to receive a lane change signal for the vehicle 1, in operation 700. Then, the speed sensor 50 may be configured to sense the driving speed of the vehicle 1, in operation 710, and transfer information regarding the sensed driving speed to the controller 100. Additionally, the distance sensor 200 may be configured to sense a distance between the vehicle 1 and the first target vehicle A, and a distance between the vehicle 1 and the second target vehicle B, in operation 720, and transfer data of the sensed distances to the controller 100.

Further, the controller 100 may be configured to compare the distance between the vehicle 1 and the first target vehicle A to a predetermined distance d1, in operation 730. When the controller 100 determines that the distance between the vehicle 1 and the first target vehicle A is greater than or equal to the predetermined distance d1, the controller 100 may be configured to operate the speed controller 70 to increase the driving speed of the vehicle 1, in operation 740. Meanwhile, when the controller 100 determines that the distance between the vehicle 1 and the first target vehicle A is less than the predetermined distance d1, the controller 100 may be configured to operate the speed controller 70 to decrease the driving speed of the vehicle 1, in operation 750.

The speed information acquirer 60 may be configured to sense the driving speed of the first target vehicle A travelling ahead of the vehicle 1, in operation 760, and transfer data of the driving speed to the controller 100. The controller 100 may be configured to compare the speed of the first target vehicle A acquired by the speed information acquirer 60 to the speed of the vehicle 1, in operation 770. When the controller 100 determines that the speed of the first target vehicle A is greater than or equal to the speed of the vehicle 1, the controller 100 may be configured to operate the speed controller 70 to increase the driving speed of the vehicle 1, in operation 780. Meanwhile, when the controller 100 determines that the speed of the first target vehicle A is less than the speed of the vehicle 1, the controller 100 may be configured to operate the speed controller 70 to decrease the driving speed of the vehicle 1, in operation 790.

FIG. 12 is a flowchart illustrating a method of controlling the vehicle 1 such that the controller 100 adjusts the driving speed of the vehicle 1 by reflecting speed information and distance information of the second target vehicle B when the vehicle 1 changes lanes. Referring to FIG. 12, the controller 100 may be configured to receive a lane change signal for the vehicle 1, in operation 800. Then, the speed sensor 50 may be configured to sense the driving speed of the vehicle 1, in operation 810, and transfer information regarding the sensed driving speed to the controller 100. The distance sensor 200 may be configured to sense a distance between the vehicle 1 and the first target vehicle A, and a distance between the vehicle 1 and the second target vehicle B, in operation 820, and transfer data of the sensed distances to the controller 100.

Additionally, the controller 100 may be configured to compare the distance between the vehicle 1 and the second target vehicle B to a predetermined distance d1, in operation 830. When the controller 100 determines that the distance between the vehicle 1 and the second target vehicle B is greater than or equal to the predetermined distance d1, the controller 100 may be configured to operate the speed controller 70 to increase the driving speed of the vehicle 1, in operation 840. Meanwhile, when the controller 100 determines that the distance between the vehicle 1 and the second target vehicle B is less than the predetermined distance d1, the controller 100 may be configured to operate the speed controller 70 to decrease the driving speed of the vehicle 1, in operation 850.

The speed information acquirer 60 may be configured to sense the driving speed of the second target vehicle B traveling ahead of the traveling vehicle 1, in operation 860, and transfer data of the driving speed to the controller 100. Then, the controller 100 may be configured to compare the speed of the second target vehicle B acquired by the speed information acquirer 60 to the speed of the vehicle 1, in operation 870. When the controller 100 determines that the speed of the second target vehicle B is greater than or equal to the speed of the vehicle 1, the controller 100 may be configured to operate the speed controller 70 to increase the driving speed of the vehicle 1, in operation 880. Meanwhile, when the controller 100 determines that the speed of the second target vehicle B is less than the speed of the vehicle 1, the controller 100 may be configured to operate the speed controller 70 to decrease the driving speed of the vehicle 1, in operation 890.

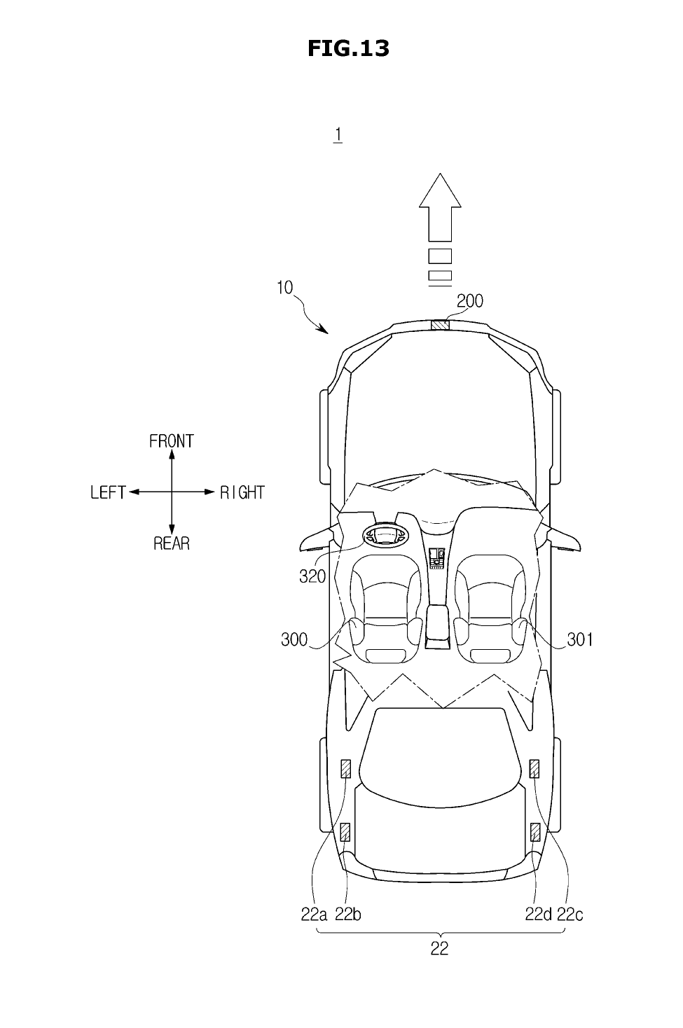

FIG. 13 shows a vehicle including a rear side vehicle sensor, according to an exemplary embodiment of the present disclosure. The rear side vehicle sensor 22 may be configured to detect whether an object, for example, a pedestrian or another vehicle is present or approaches in the side direction of the vehicle 1, in the rear direction of the vehicle 1, or in an arbitrary direction (hereinafter, referred to as a rear side direction) between the side and rear directions of the vehicle 1. The rear side vehicle sensor 22 may be disposed at an appropriate position to detect an object, for example, another vehicle present in the side direction of the vehicle 1, in the rear direction of the vehicle 1, or in the rear side direction of the vehicle 1, as shown in FIG. 13.

According to an exemplary embodiment, a plurality of rear side vehicle sensors 22 may be disposed at the left and right portions of the vehicle 1 to recognize an object in an arbitrary direction (hereinafter, referred to as a left rear direction) between the left and rear directions of the vehicle 1 and in an arbitrary direction (hereinafter, referred to as a right rear direction) between the right and rear directions of the vehicle 1. For example, a first rear side vehicle sensor 22a or a second rear side vehicle sensor 22b may be disposed on the left surface of the vehicle 1, and a third rear side vehicle sensor 22c or a fourth rear side vehicle sensor 22d may be disposed on the right surface of the vehicle 1.

Additionally, according to an exemplary embodiment, a plurality of rear side vehicle sensors 22 may be disposed at several locations to recognize another vehicle properly. For example, the first rear side vehicle sensor 22a and the second rear side vehicle sensor 22b may be respectively disposed on the left C-pillar and the left rear fender of the vehicle 1 to individually recognize presence or an approach of a pedestrian or another vehicle. Likewise, the third rear side vehicle sensor 22c and the fourth rear side vehicle sensor 22d may be respectively disposed on the right C-pillar and the right rear fender of the vehicle 1 so as to individually recognize presence or an approach of another vehicle. An example in which the rear side vehicle sensor 22 is installed has been described above. However, the installation location of the rear side vehicle sensor 22 is not limited to this, and the rear side vehicle sensor 22 may be installed at various locations (e.g., around the tail lamps 17) as considered by a designer.

The rear side vehicle sensor 22 may be configured to detect whether another vehicle is preset or approaches in the left direction of the vehicle 1, in the right direction of the vehicle 1, in the rear direction of the vehicle 1, in the left rear direction of the vehicle 1, or in the right rear direction of the vehicle 1, using electromagnetic waves, laser light, etc. For example, as shown in FIG. 8, the rear side vehicle sensor 22 may be configured to irradiate electromagnetic waves such as microwaves or millimeter waves, pulse laser light, ultrasonic waves, or infrared light, in the left direction of the vehicle 1, in the right direction of the vehicle 1, in the rear direction of the vehicle 1, in the left rear direction of the vehicle 1, or in the right rear direction of the vehicle 1, and receive pulse laser light, ultrasonic waves, or infrared light reflected or scattered from an object located in the left direction of the vehicle 1, in the right direction of the vehicle 1, in the rear direction of the vehicle 1, in the left rear direction of the vehicle 1, or in the right rear direction of the vehicle 1, to thus determine the presence of the object.

In particular, the rear side vehicle sensor 22 may be further configured to determine a distance to the object using time of arrival of the irradiated electromagnetic waves, pulse laser light, ultrasonic waves, or infrared waves. Also, according to an exemplary embodiment, the rear side vehicle sensor 22 may be configured to receive visible light reflected or scattered from an object present in the left direction, in the right direction, in the rear direction, in the left rear direction, or in the right rear direction to thus determine presence of an object. According to which one of electromagnetic waves, pulse laser light, ultrasonic waves, infrared light, and visible light is used, a distance to another preceding vehicle sensed by the distance sensor 200 may change, or the influence of weather or illuminance may change when another vehicle is sensed by the distance sensor 200, as described above.

By using electromagnetic waves, pulse laser light, ultrasonic waves, infrared light, or visible light, the vehicle 1, more particularly, the controller 100 may be configured to detect another vehicle in the left direction, right direction, rear direction, left rear direction, or right rear direction of the vehicle 1 and traveling in a different lane than the vehicle 1. The rear side vehicle sensor 22 may be implemented with various devices, such as, for example, a radar using millimeter waves or microwaves, LiDAR using pulse laser light, vision using visible light, an infrared sensor using infrared light, or an ultrasonic sensor using ultrasonic waves. The rear side vehicle sensor 22 may be implemented with any one of the above-mentioned devices, or a combination of two or more of the above-mentioned devices. When the vehicle 1 includes the plurality of rear side vehicle sensors 22, the rear side vehicle sensors 22 may be implemented with the same type of apparatuses or different types of apparatuses. For example, the rear side vehicle sensors 22a and 22c disposed in the C-pillar may be implemented with LiDARs, and the rear side vehicle sensors 22b and 22d disposed in the rear fenders may be implemented with ultrasonic sensors or infrared sensors. The rear side vehicle sensor 22 may be implemented with any other apparatus or a combination as considered by a designer.

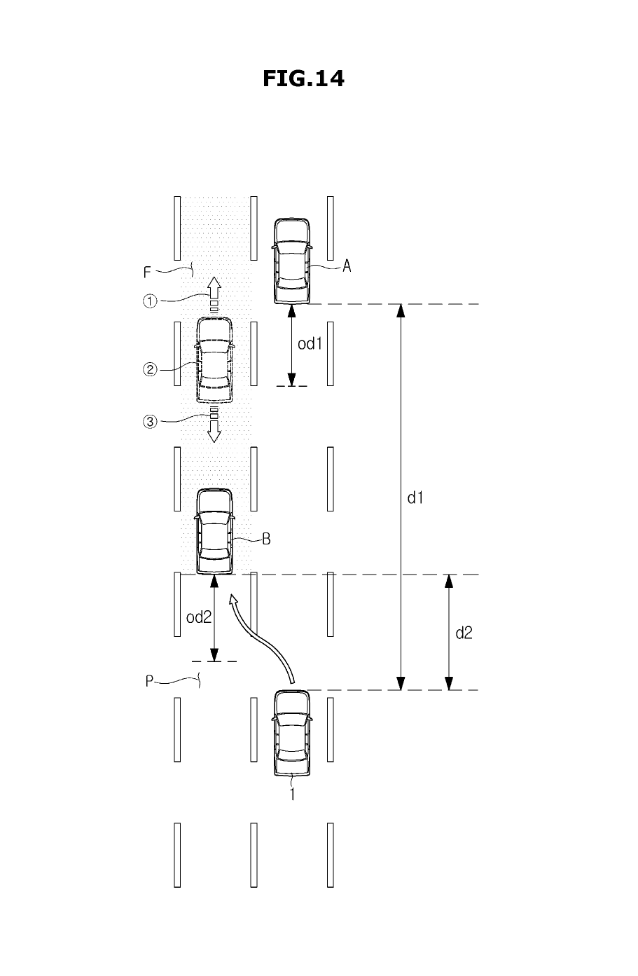

FIGS. 14, 15, and 16 are conceptual views for describing a method of adjusting the speed of a vehicle according to the position of another vehicle traveling in a target lane, according to another exemplary embodiment of the present disclosure. FIG. 14, shows when the vehicle 1 changes a lane to the left lane (e.g., a target lane), a second target vehicle B traveling in the target lane is located in a front area E In particular, the controller 100 may be configured to adjust the driving speed of the vehicle 1 based on the speed of the first target vehicle A, the speed of the second target vehicle B, a distance between the vehicle 1 and the first target vehicle A, and a distance between the vehicle 1 and the second target vehicle B. This operation has been described above with reference to FIGS. 6 and 7, and accordingly, further descriptions thereof will be omitted.

Herein, the “front area F” is an area to which the second target vehicle B is preset when the second target vehicle B is located ahead of the vehicle 1 by a predetermined distance or greater, based on a distance between the vehicle 1 and the second target vehicle B. The front area F may change relatively based on the position of the vehicle 1. Additionally, the “back area P” is an area to which the second target vehicle B is present when the second target vehicle B is located behind the vehicle 1 by a predetermined distance or greater, based on a distance between the vehicle 1 and the second target vehicle B. The back area P may change relatively based on the position of the vehicle 1.

As shown in FIG. 14, in a case \textcircled{1} in which the second target vehicle B is located in the front area F, and the speed of the second target vehicle B increases gradually to increase the distance to the vehicle 1, or in a case \textcircled{2} in which the second target vehicle B travels at a substantially constant speed, the controller 100 may be configured to adjust the driving speed of the vehicle 1 in consideration of the first safety distance od1 for the first target vehicle A and the second safety distance od2 for the second target vehicle B. Accordingly, the vehicle 1 may change the lane to travel behind the second target vehicle B, in consideration of the second safety distance od2 for the second target vehicle B.

Meanwhile, in a case \textcircled{3} in which the speed of the second target vehicle B decreases gradually to decrease the distance between the second target vehicle B and the vehicle 1, the controller 100 may be configured to generate a control command for decreasing the speed of the vehicle 1. In particular, when the speed of the second target vehicle B decreases substantially, the second safety distance od2 may not be capable of being maintained sufficiently to avoid a potential collision. Accordingly, the controller 100 may be configured to operate the vehicle 1 to not change the lane (e.g., prevent lane change) until the second target vehicle B enters the back area P, and adjust the driving speed of the vehicle 1 to allow the vehicle 1 to change the lane in consideration of the first safety distance od1 for the first target vehicle A after the second target vehicle B enters the back area P.

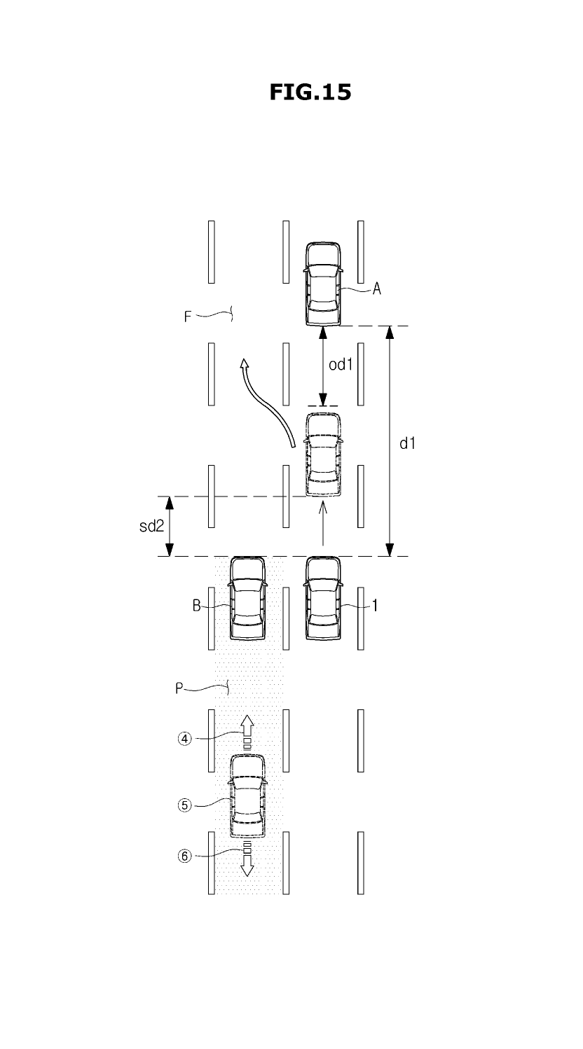

FIG. 15 shows when the driver's vehicle 1 intends to change the lane to the left lane, the second target vehicle B traveling in the target lane is located in the back area P. In particular, the controller 100 may be configured to adjust the driving speed of the vehicle 1, in consideration of the speed of the first target vehicle A and a distance between the vehicle 1 and the first target vehicle A.

As shown in FIG. 15, in a case \textcircled{6} in which the second target vehicle B is located in the back area P, and the speed of the second target vehicle B decreases gradually to increase the distance to the vehicle 1, or in a case \textcircled{5} in which the second target vehicle B travels at a substantially constant speed, the controller 100 may be configured to adjust the driving speed of the vehicle 1 in consideration of only the first safety distance od1 for the first target vehicle A. Accordingly, the vehicle 1 may change the lane to travel ahead of the second target vehicle B, in consideration of the first safety distance od1 of the first target vehicle A. Accordingly, a rear safety distance sd2 may be required to be maintained to prevent the vehicle 1 from colliding with the second target vehicle B approaching behind after the vehicle 1 changes the lane, as shown in FIG. 15.

In a case \textcircled{4} in which the speed of the second target vehicle B increases gradually to approach the vehicle 1, the controller 100 may be configured to generate a control command for decreasing the speed of the vehicle 1. When the speed of the second target vehicle B increases substantially, the rear safety distance sd2 is not capable of being maintained to prevent a potential collision. Accordingly, the controller 100 may be configured to prevent the vehicle 1 from changing the lane until the second target vehicle B enters the front area F, and adjust the driving speed of the vehicle 1 to allow the vehicle 1 to change the lane in consideration of the first safety distance od1 for the first target vehicle A and the second safety distance od2 for the second target vehicle B after the second target vehicle B enters the front area F.

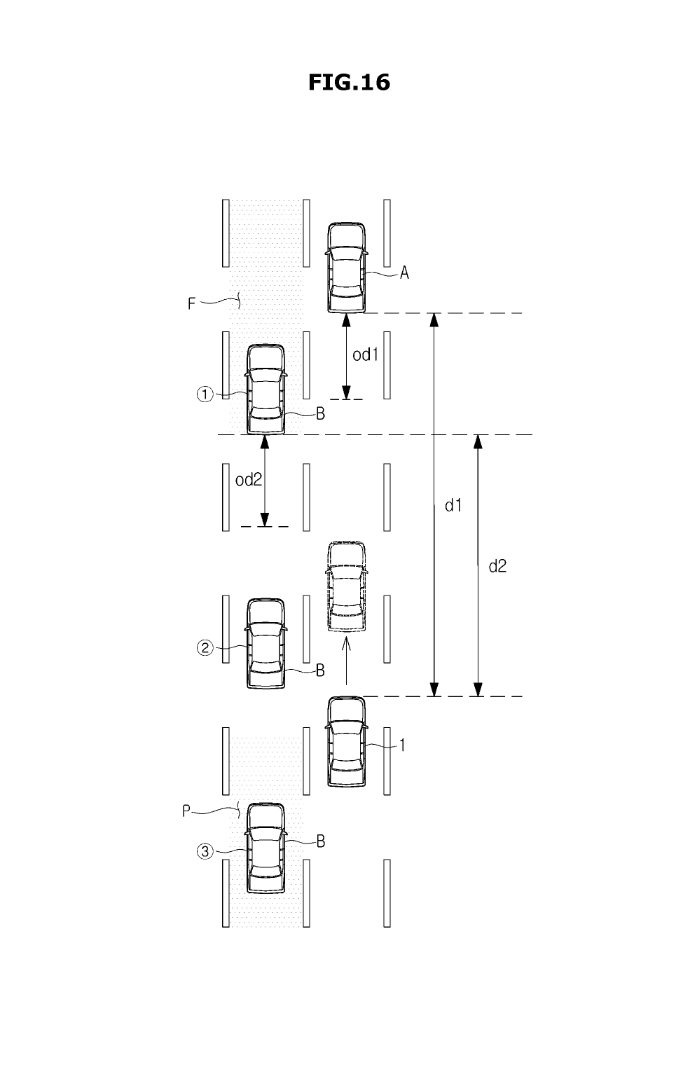

Referring to FIG. 16, there is a case \textcircled{1} in which when the vehicle 1 changes the lane to the left lane (e.g., a target lane), the second target vehicle B traveling in the target lane is located in the front area E In particular, the controller 100 may be configured to adjust the driving speed of the vehicle 1 in consideration of the first safety distance od1 for the first target vehicle A and the second safety distance od2 for the second target vehicle B. Additionally, in a case \textcircled{3} in which the second target vehicle B traveling in the target lane is located in the back area P, the controller 100 may be configured to adjust the driving speed of the vehicle 1 in consideration of the first safety distance od1 of the first target vehicle A. This operation has been described above with reference to FIGS. 14 and 15, and accordingly, further descriptions thereof will be omitted.

As shown in FIG. 16, in a case \textcircled{2} in which the second target vehicle B traveling in the target lane is located between the front area F and the back area P, the second safety distance od2 or the rear safety distance sd2 may be not maintained when the vehicle 1 changes lanes. Accordingly, the controller 100 may be configured to decrease the driving speed of the vehicle 1 and thus, when the second target vehicle B enters the front area F, the vehicle 1 may change the lane to travel behind the second target vehicle B, in consideration of the first safety distance od1 for the first target vehicle A and the second safety distance od2 for the second target vehicle B. Alternatively, the controller 100 may be configured to increase the driving speed of the vehicle 1 and thus, when the second target vehicle B enters the back area P, the vehicle 1 may change the lane to travel ahead of the second target vehicle B, in consideration of the first safety distance od1 for the first target vehicle A and the rear safety distance sd2 for the second target vehicle B.

The vehicle 1 for implementing the exemplary embodiments of FIGS. 14, 15, and 16 may sense the second target vehicle B traveling in the target lane using the rear side vehicle sensor 22 described above with reference to FIG. 13. Therefore, by adjusting the driving speed of a vehicle when the vehicle changes lanes in consideration of a safety distance between the vehicle and a preceding vehicle traveling on the lane of the vehicle, a safety distance between the vehicle and a preceding vehicle traveling in a target lane which the vehicle intends to enter, and the speeds of the preceding vehicles, the vehicle may safely and more easily change the lanes.

Although a few exemplary embodiments of the present disclosure have been shown and described, it would be appreciated by those skilled in the art that changes may be made in these exemplary embodiments without departing from the principles and spirit of the disclosure, the scope of which is defined in the claims and their equivalents.

What is claimed is:

1. A vehicle, comprising:
a speed sensor configured to sense driving speed of the vehicle;
a speed controller configured to adjust the driving speed of the vehicle;
a distance sensor configured to sense a distance between the vehicle and a first target vehicle and a distance between the vehicle and a second target vehicle; and
a controller configured to determine, when a lane change signal for the vehicle is received, a first safety distance between the vehicle and the first target vehicle and a second safety distance between the vehicle and the second target vehicle, based on the distances sensed by the distance sensor, and to operate the speed controller to adjust the driving speed of the vehicle based on the first safety distance and the second safety distance.

2. The vehicle according to claim 1, wherein the first safety distance is a distance required between the vehicle and the first target vehicle when changing lanes, and wherein the second safety distance is a distance required between the vehicle and the second target vehicle when changing lanes.

3. The vehicle according to claim 1, wherein the controller is configured to select one of the first safety distance and the second safety distance, as a target vehicle distance required by the vehicle when changing lanes, wherein the selected one of the first safety distance and the second safety distance is a distance for a target vehicle to which the vehicle is located closer to than the other target vehicle.

4. The vehicle according to claim 3, wherein when the first safety distance is selected as a target vehicle distance required by the vehicle when changing lanes, the controller is configured to operate the speed controller to maintain the target vehicle distance between the vehicle and the first target vehicle.

5. The vehicle according to claim 3, wherein when the second safety distance is selected as a target vehicle distance required by the vehicle when changing lanes, the controller is configured to operate the speed controller to maintain the target vehicle distance between the vehicle and the second target vehicle.

6. The vehicle according to claim 1, wherein when the distance between the vehicle and the first target vehicle is greater than or equal to a predetermined distance, the controller is configured to operate the speed controller to increase the driving speed of the vehicle.

7. The vehicle according to claim 1, wherein when the distance between the vehicle and the first target vehicle is less than a predetermined distance, the controller is configured to operate the speed controller to decrease the driving speed of the vehicle.

8. The vehicle according to claim 1, wherein when the distance between the vehicle and the second target vehicle is greater than or equal to a predetermined distance, the controller is configured to operate the speed controller to increase the driving speed of the vehicle.

9. The vehicle according to claim 1, wherein when the distance between the vehicle and the second target vehicle is less than a predetermined distance, the controller is configured to operate the speed controller to decrease the driving speed of the vehicle.

10. The vehicle according to claim 1, further comprising:
a speed information acquirer configured to sense speed of the first target vehicle and speed of the second target vehicle.

11. The vehicle according to claim 10, wherein when the sensed speed of the first target vehicle is greater than or equal to the speed of the vehicle, the controller is configured to operate the speed controller to increase the driving speed of the vehicle.

12. The vehicle according to claim 10, wherein when the sensed speed of the first target vehicle is less than the speed of the vehicle, the controller is configured to operate the speed controller to decrease the driving speed of the vehicle.

13. The vehicle according to claim 10, wherein when the sensed speed of the second target vehicle is greater than or equal to the speed of the vehicle, the controller is configured to operate the speed controller to increase the driving speed of the vehicle.

14. The vehicle according to claim 10, wherein when the sensed speed of the second target vehicle is less than the speed of the vehicle, the controller is configured to operate the speed controller to decrease the driving speed of the vehicle.

15. The vehicle according to claim 10, wherein the controller is configured to determine a minimum value of driving speed required for the vehicle to travel, based on at least one selected from the group consisting of: the first safety distance, the second safety distance, the sensed speed of the first target vehicle, and the sensed speed of the second target vehicle.

16. The vehicle according to claim 15, wherein the controller is configured to operate the speed controller based on the minimum value of the driving speed.

17. The vehicle according to claim 1, wherein the first target vehicle is located in the same lane as the vehicle, and wherein the second target vehicle is located in a target lane which the vehicle intends to enter.

18. A method of controlling a vehicle, comprising:
receiving, by a controller, a lane change signal for the vehicle;
sensing, by the controller, a driving speed of the vehicle;
sensing, by the controller, a distance between the vehicle and a first target vehicle, and a distance between the vehicle and a second target vehicle;
determining, by the controller, a first safety distance between the vehicle and the first target vehicle and a second safety distance between the vehicle and the second target vehicle, based on the sensed distances; and
operating, by the controller, a speed controller to adjust the driving speed of the vehicle based on the first safety distance and the second safety distance.

19. The method according to claim 18, further comprising:
selecting, by the controller, one of the first safety distance and the second safety distance, as a target vehicle distance required by the vehicle when changing lanes, wherein the selected one of the first safety distance and the second safety distance is a distance for a target vehicle to which the vehicle is located closer to than the other target vehicle.

20. The method according to claim 19, wherein the operating of the speed controller comprises:
when the first safety distance is selected as a target vehicle distance required the vehicle when changing lanes, operating, by the controller, the speed controller to maintain the target vehicle distance between the vehicle and the first target vehicle.

21. The method according to claim 19, wherein the operating of the speed controller comprises:
when the second safety distance is selected as a target vehicle distance required by the vehicle when changing lanes, operating, by the controller, the speed controller to maintain the target vehicle distance between the vehicle and the second target vehicle.

22. The method according to claim 18, wherein the operating of the speed controller comprises:
when the distance between the vehicle and the first target vehicle is greater than or equal to a predetermined distance, operating, by the controller, the speed controller to increase the driving speed of the vehicle.

23. The method according to claim 18, wherein the operating of the speed controller comprises:
when the distance between the vehicle and the first target vehicle is less than a predetermined distance, operating, by the controller, the speed controller to decrease the driving speed of the vehicle.

24. The method according to claim 18, wherein the operating of the speed controller comprises;
when the distance between the vehicle and the second target vehicle is greater than or equal to a predetermined distance, operating, by the controller, the speed controller to increase the driving speed of the vehicle.

25. The method according to claim 18, wherein the operating of the speed controller comprises:
when the distance between the vehicle and the second target vehicle is less than a predetermined distance, operating, by the controller, the speed controller to decrease the driving speed of the vehicle.

26. The method according to claim 18, further comprising:
detecting, by the controller, a speed of the first target vehicle and a speed of the second target vehicle.

27. The method according to claim 26, wherein the operating of the speed controller comprises:
when the sensed speed of the first target vehicle is greater than or equal to the speed of the vehicle, operating, by the controller, the speed controller to increase the driving speed of the vehicle.

28. The method according to claim 26, wherein the operating of the speed controller comprises;
when the sensed speed of the first target vehicle is less than the speed of the vehicle, operating, by the controller, the speed controller to decrease the driving speed of the vehicle.

29. The method according to claim 26, wherein the operating of the speed controller comprises;
when the sensed speed of the second target vehicle is greater than or equal to the speed of the vehicle, operating, by the controller, the speed controller to increase the driving speed of the vehicle.

30. The method according to claim 26, wherein the operating of the speed controller comprises;
when the sensed speed of the second target vehicle is less than the speed of the vehicle, operating, by the controller, the speed controller to decrease the driving speed of the vehicle.

31. The method according to claim 26, further comprising:
determining, by the controller, a minimum value of driving speed required for the vehicle to travel, based on at least one selected from the group consisting of: the first safety distance, the second safety distance, the sensed speed of the first target vehicle, and the sensed speed of the second target vehicle.

32. The method according to claim 31, wherein the operating of the speed controller comprises:
operating, by the controller, the speed controller based on the minimum value of the driving speed.
